(19) United States
(12) Patent Application Publication
(10) Pub. No.: US 2025/0353176 A1
(43) Pub. Date: Nov. 20, 2025

(54) DYNAMICS OPTIMIZATION METHOD AND SYSTEM FOR ROBOTIC DEVICES

(71) Applicants: Moritz Niklaus Bächer, Zürich (CH); Christian Gabriel Schumacher, Aarau (CH); Lars Espen Knoop, Birmensdorf (CH); Guirec G.H.F. Maloisel, Zürich (CH); Ruben Jelle Grandia, Burbank, CA (US)

(72) Inventors: Moritz Niklaus Bächer, Zürich (CH); Christian Gabriel Schumacher, Aarau (CH); Lars Espen Knoop, Birmensdorf (CH); Guirec G.H.F. Maloisel, Zürich (CH); Ruben Jelle Grandia, Burbank, CA (US)

(21) Appl. No.: 19/200,927

(22) Filed: May 7, 2025

Related U.S. Application Data
(60) Provisional application No. 63/649,209, filed on May 17, 2024.

(51) Int. Cl. B25J 9/16

(52) U.S. Cl. CPC B25J 9/1664; B25J 9/161; B25J 9/163

(57) ABSTRACT

In one embodiment, a computer-implemented method for generating a dynamics model of a robotic device is disclosed. The method may include receiving, via a processor, a target animation for the robotic device; receiving, via the processor, a kinematic model of the robotic device, the kinematic model comprising a movement characteristic of a first robotic component of the robotic device; generating, via the processor, a motion representation for the first robotic component based on the target animation and the kinematic model; generating, via the processor, a kinematic constraint of the first robotic component based on a dynamic characteristic of the first robotic component; generating, via the processor, a dynamics model of the first robotic component based on the motion representation and the kinematic constraint; and deploying, via the processor, the dynamics model to the robotic device.

### CROSS-REFERENCE TO RELATED APPLICATIONS

This application claims the benefit of priority under 35 U.S.C. § 119 (e) and 37 C.F.R. § 1.78 to provisional application No. 63/649,209 filed on May 17, 2024, titled “A Versatile Implicitly-Integrated Quaternion-Based Rigid Body Dynamics”, and is related to U.S. patent application Ser. No. 18/669,623, titled “DESIGN SYSTEM FOR ROBOTIC DEVICES” and filed May 21, 2024, both of which are incorporated herein by reference in their entireties.

### BACKGROUND

Rigid bodies are omnipresent in virtual environments as well as in mechanical systems in the real world. Simulating the dynamics of such systems with arbitrary kinematic structures, including loops and passive degrees of freedom, requires a constraint-based formulation. Accurate simulation of such systems require that constraints remain preserved-in particular in the vicinity of singularities where even small constraint violations can cause entirely wrong simulations. Common explicit and semi-explicit time-stepping schemes generally do not offer guarantees on constraint satisfaction for arbitrary systems and steps sizes. In contrast, implicit integration schemes allow the inclusion of kinematic constraints at the next time step and hence solving for them up to a specified tolerance. However, for implicit schemes, rotational motion presents a challenge. Quaternions are a common representation choice, being compact and singularity-free; however, quaternion representations present technical challenges when used for handling a unit-length constraint within such an implicit scheme. As discussed herein, a unit-length constraint represents a constraint limiting the magnitude of a vector. Further, the specialized multiplicative algebra of implicit Lie-group integrators complicates the use of these formulations in downstream applications. As discussed herein, a Lie-group integrator represents a numerical integration method for coordinate-independent operations.

Regarding rigid body dynamics (RBD), motion equations for a single body differ in how they represent the single body's orientation and angular velocity. Unit quaternions are free of singularities, but only represent rotations if they are kept unit length. Renormalization may introduce inaccuracies due to projection operations. The use of non-unit-length quaternions may be used for single bodies, but has not been extended to incorporate constraints. Variational integrators inherently maintain unit length by using an exponential map; however, their multiplicative update hinders downstream use (e.g., differentiability). The general incorporation of kinematic constraints, a.k.a. geometric or bilateral constraints, into RBD may include an unintuitive scaling due to the use of the imaginary part of the quaternion.

Regarding constrained multibody dynamics, rigid body systems with many loop-closure constraints are stiff systems and hence, challenging to stably integrate. Methods for articulated or hybrid systems with only a few kinematic loops are therefore more common, where minimal coordinate formulations are frequently used. Other methods may focus on the resolution of unilateral constraints or frictional contact, or relax the problem by assuming some or all bodies to be flexible or at least close-to-rigid. This flexibility not only reduces the stiffness in the system, but also regularizes subspaces in constraint forces and torques. Simulation software in graphics and robotics support both bilateral and unilateral constraints and primarily use semi-implicit integration, where velocities are implicitly solved and positions are explicitly integrated thereafter. This relies on stabilized velocity constraints, which require tuning stabilization parameters and cannot guarantee position constraint satisfaction.

### BRIEF SUMMARY

In one embodiment, a computer-implemented method for generating a dynamics model of a robotic device is disclosed. The method may include receiving, via a processor, a target animation for the robotic device; receiving, via the processor, a kinematic model of the robotic device, the kinematic model comprising a movement characteristic of a first robotic component of the robotic device; generating, via the processor, a motion representation for the first robotic component based on the target animation and the kinematic model; generating, via the processor, a kinematic constraint of the first robotic component based on a dynamic characteristic of the first robotic component; generating, via the processor, a dynamics model of the first robotic component based on the motion representation and the kinematic constraint; and deploying, via the processor, the dynamics model to the robotic device.

Optionally, in some embodiments, the kinematic model includes at least one of an over-constrained, over-actuated, under-constrained, or under-actuated model of the robotic device.

Optionally, in some embodiments, the movement characteristic of the first robotic component includes a parameter defining a relative motion between the first robotic component and a second robotic component.

Optionally, in some embodiments, the motion representation for the first robotic component maintains dynamic equilibrium in the first robotic component during a motion of the first robotic component.

Optionally, in some embodiments, the motion representation for the first robotic component is based on a Euler-Lagrange relationship.

Optionally, in some embodiments, the kinematic constraint includes a translational constraint restricting a translational motion between the first robotic component and a second robotic component of the robotic device.

Optionally, in some embodiments, the kinematic constraint includes a rotational constraint restricting an angular motion between the first robotic component and a second robotic component of the robotic device.

Optionally, in some embodiments, the dynamic characteristic of the first robotic component includes at least one of a mass of the first robotic component, a torque applied to the first robotic component, or a force applied to the first robotic component.

Optionally, in some embodiments, generating the kinematic constraint of the first robotic component based on the dynamic characteristic of the first robotic component includes: determining a dynamic tolerance of the first robotic component based on the dynamic characteristic; and generating the kinematic constraint to restrict a dynamic motion of the first robotic component within the dynamic tolerance.

Optionally, in some embodiments, generating the dynamics model of the first robotic component based on the motion representation and the kinematic constraint includes solving the motion representation to satisfy the kinematic constraint.

In another embodiment, a system for generating a dynamics model of a robotic device is disclosed. The system may include the robotic device; a datastore; and a processor configured by instructions to perform operations including: receiving a target animation for the robotic device; receiving a kinematic model of the robotic device, the kinematic model comprising a movement characteristic of a first robotic component of the robotic device; generating a motion representation for the first robotic component based on the target animation and the kinematic model; generating a kinematic constraint of the first robotic component based on a dynamic characteristic of the first robotic component; generating a dynamics model of the first robotic component based on the motion representation and the kinematic constraint; and deploying the dynamics model to the robotic device.

Optionally, in some embodiments, the kinematic model includes at least one of an over-constrained, over-actuated, under-constrained, or under-actuated model of the robotic device.

Optionally, in some embodiments, the movement characteristic of the first robotic component includes a parameter defining a relative motion between the first robotic component and a second robotic component.

Optionally, in some embodiments, the motion representation for the first robotic component maintains dynamic equilibrium in the first robotic component during a motion of the first robotic component.

Optionally, in some embodiments, the motion representation for the first robotic component is based on a Euler-Lagrange relationship.

Optionally, in some embodiments, the kinematic constraint includes a translational constraint restricting a translational motion between the first robotic component and a second robotic component of the robotic device.

Optionally, in some embodiments, the kinematic constraint includes a rotational constraint restricting an angular motion between the first robotic component and a second robotic component of the robotic device.

Optionally, in some embodiments, the dynamic characteristic of the first robotic component includes at least one of a mass of the first robotic component, a torque applied to the first robotic component, or a force applied to the first robotic component.

Optionally, in some embodiments, generating the kinematic constraint of the first robotic component based on the dynamic characteristic of the first robotic component includes: determining a dynamic tolerance of the first robotic component based on the dynamic characteristic; and generating the kinematic constraint to restrict a dynamic motion of the first robotic component within the dynamic tolerance.

Optionally, in some embodiments, generating the dynamics model of the first robotic component based on the motion representation and the kinematic constraint includes solving the motion representation to satisfy the kinematic constraint.

### BRIEF DESCRIPTION OF THE SEVERAL VIEWS OF THE DRAWINGS

FIG. 1 illustrates an example of a computer-implemented dynamics optimization system.

FIG. 2 is a flow diagram for generating a dynamics model with the dynamics optimization system of FIG. 1.

FIG. 3A illustrates an example translational motion of a robotic component as described with respect to method 200.

FIG. 3B illustrates an example translational motion of a robotic component as described with respect to method 200.

FIG. 3C illustrates an example translational motion of a robotic component as described with respect to method 200.

FIG. 3D illustrates an example translational motion of a robotic component as described with respect to method 200.

FIG. 4A illustrates an example rotational motion of a robotic component as described with respect to method 200.

FIG. 4B illustrates an example rotational motion of a robotic component as described with respect to method 200.

FIG. 4C illustrates an example rotational motion of a robotic component as described with respect to method 200.

FIG. 4D illustrates an example rotational motion of a robotic component as described with respect to method 200.

FIG. 5A illustrates an example dynamics model of a robotic device as described with respect to method 200.

FIG. 5B illustrates an example dynamics model of a robotic device as described with respect to method 200.

FIG. 5C illustrates an example dynamics model of a robotic device as described with respect to method 200.

FIG. 5D illustrates an example graph of the performance of a dynamics model as described with respect to method 200.

FIG. 6 illustrates an example dynamics model of a robotic device as described with respect to method 200.

FIG. 7A illustrates an example dynamics model of a robotic device as described with respect to method 200.

FIG. 7B illustrates an example graph of the performance of a dynamics model as described with respect to FIG. 7A.

FIG. 8 is a block diagram of an example computer system suitable for use in the dynamics optimization system of FIG. 1.

### DETAILED DESCRIPTION

Robotic devices may be designed to perform a sequence of target motions. Effective design of such robotic devices may require a dynamics model simulating the dynamics of the robotic device given the real physical characteristics and constraints of the robotic device. The dynamic motion of a robotic device is defined by its mechanical joints and actuators that create the relative motion of its rigid body components. Dynamics describes the motion of the components of the robotic device under the action of physical loads such as forces, torques, couples, etc. Disclosed herein are methods and systems for generating an optimized dynamics model of the constrained rigid body dynamics (RBD) of a robotic system that satisfies kinematic constraints. Embodiments enable direct simulation of complex mechanical systems with arbitrary or pre-defined kinematic structures. The disclosed systems and methods provide improvements in the dynamics design of robotic devices, allowing faster and easier deployment of different target motions to different or new robotic devices.

In some embodiments, the systems and methods use an implicit integration scheme by deriving compatible dynamic equations expressed through the quaternion time derivative, and adopting an additive approach to quaternion updates, while enforcing quaternion unit-length as a constraint. The methods may model one or more, or all joints between rigid bodies that restrict subsets of the three translational or three rotational degrees of freedom, including position-and force-based actuation. The constraints are formulated such that Lagrange multipliers are interpretable as joint forces and torques. The methods may provide a unified solution strategy for systems with redundant constraints, over-actuation (i.e., components with more actuators than degrees of freedom), and passive degrees of freedom (i.e., degrees of freedom that are not controlled by an actuator), by eliminating redundant constraints and navigating the subspaces spanned by multipliers. As the methods may use an additive update, the methods may interface with stable (e.g., unconditionally-stable) implicit integrators. Moreover, the simulation can readily be made differentiable.

In some embodiments, the methods and systems represent the dynamic equations in terms of the quaternion time derivative, formulating an additive rather than multiplicative quaternion update, and incorporate the quaternion unit length as a constraint. This enables interfacing with implicit integration schemes for differential-algebraic equations (DAEs) and makes the simulation readily differentiable. The method may generate dynamics models for robotic systems with position-or force-based actuation and configurations with redundant kinematic constraints and over-actuation, which frequently arise in real-world systems. The method may analyze the non-uniqueness of constraint forces in such redundant and over-actuated configurations and provide the user with control over the desired solution.

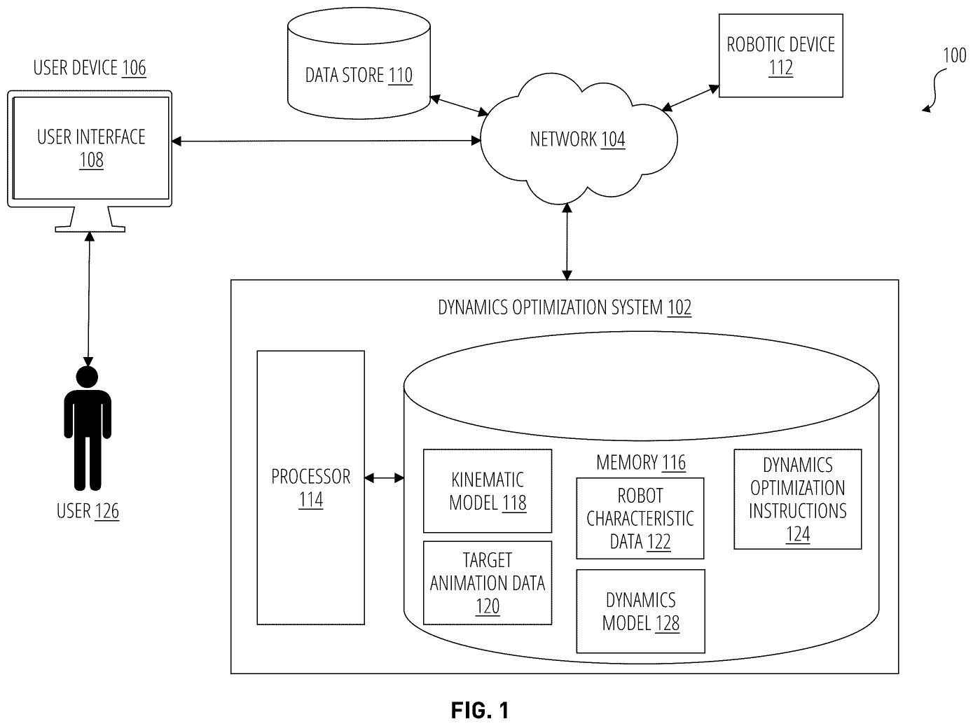

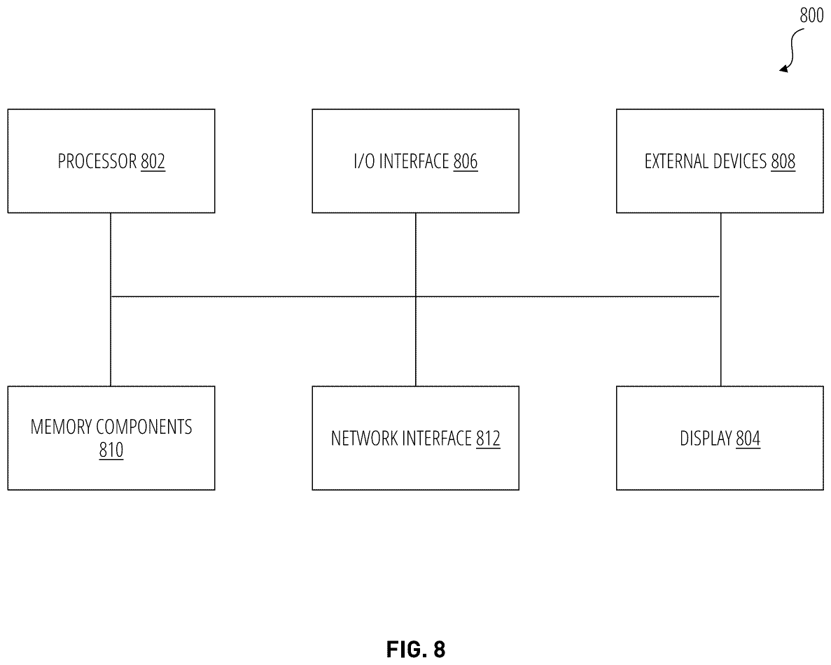

Turning now to the figures, FIG. 1 illustrates an example system 100. The system 100 generates a dynamics model 128 of robotic device 112 and deploys the dynamics model 128 to the robotic device 112. As used herein, a dynamics model 128 represents a model of the robotic device 112 designed to enable the robotic device 112 to perform a targeted motion sequence. For example, the dynamics model 128 may designate and locate actuators, materials, and other robotic components to enable the robotic device 112 to perform a desired motion sequence. The system 100 includes a user device 106, a data store 110, and the robotic device 112 in communication with a dynamics optimization system 102 either directly or via a network 104. In some embodiments, the dynamics optimization system 102 includes a processor 114 and a memory 116. The memory 116 may include or access various types of data or instructions used by the dynamics optimization system 102. Such data and instructions may include kinematic model 118, target animation data 120, robot characteristic data 122, dynamics optimization instructions 124, and the dynamics model 128 in various examples. Such data and instructions may be stored on and/or executed by a computing device as described with respect to FIG. 8.

The dynamics optimization system 102, data store 110, and robotic device 112 may be accessible by a user 126 through a user interface 108 provided by the user device 106, e.g., through a software application. In some embodiments, the dynamics optimization system 102 may be in communication with one or more user devices 106, one or more data stores 110, and one or more robotic devices 112. In some embodiments, the dynamics optimization system 102, data store 110, and robotic device 112 may be incorporated into a single device rather than as separate systems.

In some embodiments, a user 126 may engage with the system 100 through a user device 106. In some examples, the user 126 may engage with the system 100 to design and/or control a motion of the robotic device 112. For example, the user 126 may be a motion actor utilizing various motion capture devices to capture an input motion sequence or target animation to be deployed by the robotic device 112. The system 100 may receive the target animation from the user 126, generate a dynamics model 128 of the target animation for the robotic device 112, and deploy the dynamics model 128 to the robotic device 112. In another example, the user 126 may generate an input motion sequence via an animation system.

In some embodiments, the user device 106 may be a device utilized by a user 126. The user device 106 may communicate with the dynamics optimization system 102 (e.g., via the network 104). The user device 106 and network 104 are discussed in more detail with respect to FIG. 8. In some examples, the dynamics optimization system 102 is executed on the user device 106. In such examples, communication between the dynamics optimization system 102 and user device 106 may not be via network 104. In some examples, a user 126 may input a request to generate a dynamics model 128 for the robotic device 112 through the user interface 108. The user device 106 may communicate the request to the dynamics optimization system 102. The dynamics optimization system 102 may generate the dynamics model 128 and transmit data of the dynamics model 128 to the user 126 via the user interface 108. The user device 106 may be suitable to simulate or model any aspect of a robotic device 112 herein, such as the type and number of any bodies, links, linkages, or actuators of a robotic device 112, as well as the dynamic movement of the resulting robotic device 112.

In some embodiments, the dynamics optimization system 102 may be in communication with a data store 110. The data store 110 may include memory storage (e.g., in a server) for storing models, simulations, and/or other data related to the dynamics model design of any robotic device 112 disclosed herein. For example, the data store 110 may store target animation data, kinematic models of the robotic device 112, geometric models of the robotic device 112, characteristics of the robotic device 112, and the like. The data store 110 may be implemented as one storage device (e.g., a physical device) or distributed across various storage devices. In some embodiments, the data store 110 may be in communication with additional systems not sown in FIG. 1. For example, the data store 110 may be in communication with a kinematics optimization system configured to generate a kinematic model of the robotic device 112.

In some embodiments, the dynamics optimization system 102 may be in communication with a robotic device 112. The robotic device 112 may include one or more robotic components, such as actuators, joints, and rigid bodies. The robotic device 112 may be configured to execute a motion sequence, such as a motion sequence retargeted to the robotic device 112 from a target animation. As used herein, retargeting a motion sequence to the robotic device 112 includes configuring the robotic device 112 to perform a motion sequence represented in a target animation. For example, the robotic device 112 may be an animatronic character with joints, actuators, and rigid bodies configured to perform designed motion sequences.

In some embodiments, the dynamics optimization system 102 includes a kinematic model 118 of the robotic device 112 stored e.g., on the memory 116. As used herein, a kinematic model represents the kinematic design and motion capabilities of a robotic device 112. For example, the kinematic model 118 of a robotic device 112 may include the kinematic motion data of the robotic device 112, such as data regarding the mechanical joints and actuators that create the relative motion of its components, and data regarding the degrees-of-freedom of respective linkages, as well as their positions, velocities, and ranges of motion.

In some examples, the dynamics optimization system 102 may receive the kinematic model 118 from the user device 106 and/or the data store 110 (e.g., via the network 104). For example, the data store 110 may store a kinematic model 118 of the robotic device 112 and the dynamics optimization system 102 may receive the kinematic model 118 from the data store 110. In other examples, the dynamics optimization system 102 may receive the kinematic model 118 from a kinematics optimization system configured to generate a kinematic model of the robotic device 112 based on a target animation. The dynamics optimization system 102 may store the kinematic model 118 in memory 116.

In some embodiments, the dynamics optimization system 102 includes target animation data 120 stored e.g., on the memory 116. The target animation data 120 may store data related to a target animation for the robotic device 112. As used herein, the target animation includes data representing a motion sequence intended to be retargeted onto the robotic device 112. For example, the target animation data 120 may include a drawn animation of a motion sequence or data of a motion sequence captured with a motion capture device. The target animation may be intended to direct a motion sequence of the robotic device 112. For example, the target animation data 120 may include a motion capture of a dance sequence that is to be retargeted on to an animatronic character and performed by the animatronic character.

The dynamics optimization system 102 may receive the target animation data 120 from the user device 106 and/or the data store 110 (e.g., via the network 104). For example, the user 126 may input a target animation via the user interface 108 of the user device 106. The dynamics optimization system 102 may receive the target animation from the user device 106 and store the target animation data 120 in memory 116.

In some embodiments, the dynamics optimization system 102 includes robot characteristic data 122 stored e.g., on the memory 116. The robot characteristic data 122 may include characteristics of the robotic device 112, such as characteristics of robotic components of the robotic device 112 related to the dynamic movement of the robotic device 112. For example, robot characteristic data 122 may include data regarding the mass of robotic components, dimensions of robotic components, force and/or torque thresholds of robotic components, and the like.

The dynamics optimization system 102 may receive the robot characteristic data 122 from the user device 106 and/or the data store 110 (e.g., via the network 104). For example, the data store 110 may store characteristic data of all robotic components of the robotic device 112. The dynamics optimization system 102 may receive the robot characteristic data 122 from the data store 110 and store the target animation data 120 in memory 116.

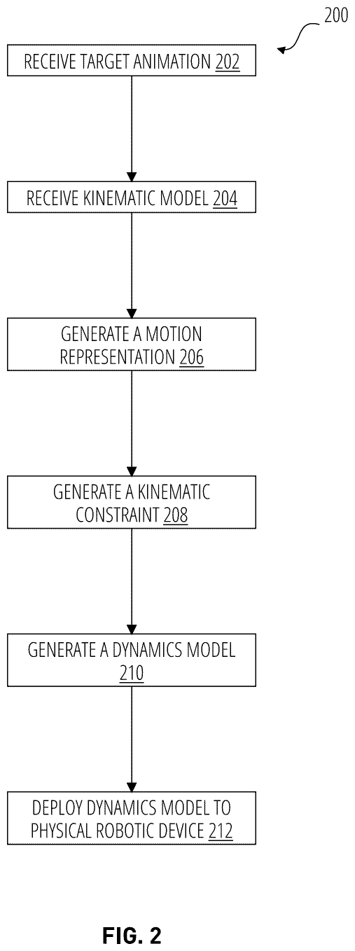

In some embodiments, the dynamics optimization system 102 includes dynamics optimization instructions 124 stored e.g., on the memory 116. The dynamics optimization instructions 124 may, when executed by the processor 114, generate and/or deploy a dynamics model 128 of the robotic device 112 based on target animation data 120 (e.g., as according to method 200). The dynamics optimization instructions 124 may include instructions to receive target animation data 120, receive kinematic model 118, generate a motion representation, generate a kinematic constraint, generate a dynamics model 128, and deploy the dynamics model 128 to the physical robotic device 112. The dynamics optimization instructions 124 are described in further detail with respect to FIG. 2.

While the data and instructions, such as the kinematic model 118, target animation data 120, robot characteristic data 122, and dynamics optimization instructions 124 are shown in FIG. 1 as being stored in the memory 116, in some examples, the data and instructions may be stored at other memory resources of the dynamics optimization system 102 and/or at locations remote from the dynamics optimization system 102, such as various databases or data stores (e.g., the data store 110). In such examples, the memory 116 of the dynamics optimization system 102 may include instructions for accessing such data and instructions from remote locations, including, for example, the locations of the data and/or specific queries used to retrieve data for use by the dynamics optimization system 102. For example, where the kinematic model 118 is stored in the data store 110, memory 116 may include instructions for how to retrieve or access the data from the data store 110.

The dynamics optimization system 102 may be implemented by or at a computing device or combinations of computing resources in various embodiments. In various examples, the dynamics optimization system 102 may be implemented by one or more servers, cloud computing resources, and/or other computing devices. The dynamics optimization system 102 may, for example, be incorporated as a module within a mobile application, software application, or a website presented through a web browser (e.g., at a laptop or desktop computer), and the like.

The components of FIG. 1 are exemplary only. In various examples, the dynamics optimization system 102 may communicate with and/or include additional components and/or functionality not shown in FIG. 1. For example, the dynamics optimization system 102 may communicate with a kinematic optimization system configured to generate kinematic models of the robotic device 112.

FIG. 2 illustrates an example method 200 for generating and deploying a dynamics model 128 of a robotic device 112 with the dynamics optimization system 102. Although the example method 200 depicts a particular sequence of operations, the sequence may be altered without departing from the scope of the present disclosure. For example, some of the operations depicted may be performed in parallel or in a different sequence that does not materially affect the function of the method 200. In other examples, different components of an example device or system that implements the method 200 may perform functions at substantially the same time or in a specific sequence. The method 200 may make use of any embodiment for generating and deploying a dynamics model 128 of a robotic device 112 disclosed herein. In operation 202, the dynamics optimization system 102 receives target animation data 120. The dynamics optimization system 102 may receive the target animation data 120 from the user device 106 and/or the data store 110 (e.g., via the network 104). As described with respect to FIG. 1, the target animation includes data representing a motion sequence intended to be retargeted onto the robotic device 112. For example, a user 126 may interact with a user interface 108 of the user device 106 to define a motion sequence that the user 126 wishes to retarget onto the robotic device 112. The user device 106 may generate target animation data 120 based on the motion sequence and transmit the target animation data 120 to the dynamics optimization system 102. In other examples, the dynamics optimization system 102 may receive the target animation data 120 from a data store 110 such as a database of animation files. The dynamics optimization system 102 may store the target animation data 120 in memory 116.

In operation 204, the dynamics optimization system 102 receives a kinematic model 118 based on the target animation data 120. The kinematic model may be generated as described, for example, in U.S. patent application Ser. No. 18/669,623, titled “DESIGN SYSTEM FOR ROBOTIC DEVICES” and filed May 21, 2024. The kinematic model 118 may define a kinematic design of the robotic device 112 capable of executing the target animation. For example, the kinematic model 118 may include the kinematic motion capabilities of the robotic device 112, such as data regarding the mechanical joints and actuators that create the relative motion of its components, and data regarding the degrees-of-freedom of respective linkages, their positions, velocities, and ranges of motion. The dynamics optimization system 102 may receive the kinematic model 118 from the data store 110, user device 106, and/or a kinematics optimization system. For example, based on the target animation data 120, a kinematics optimization system may generate a kinematic model 118 and structural design of a robotic device 112 capable of executing the target animation. The kinematics optimization system may then transmit the kinematic model 118 to the dynamics optimization system 102. The dynamics optimization system 102 may store the kinematic model 118 in memory 116.

In operation 206, the dynamics optimization system 102 generates a motion representation of the robotic device 112 based on the target animation data 120 and kinematic model 118. The motion representation of the robotic device 112 may include an equation of motion, such as a constrained dynamics equation, which represents a motion of the robotic component given dynamic characteristics of the robotic component. As used herein, the dynamic characteristics of a robotic component represent physical and/or force characteristics of the robotic component related to the dynamics of the robotic component. For example, dynamic characteristics may include the mass of the robotic component, the dimensions of the robotic component, the force and/or torque applied to the robotic component, the force and/or torque thresholds of the dynamic component, and the like. In some examples, the equation of motion may be generated to maintain dynamic equilibrium in the robotic component throughout the course of the motion. As used herein, dynamic equilibrium represents a state of balance where opposing forces acting on the robotic component are balanced, such that the net force on the robotic component is zero.

In some examples, the constrained dynamic equation of motion may be derived from the Euler-Lagrange equations according to Equation 1.

$$\frac{d}{dt} {( \frac{\partial T}{\partial \dot{s}} )}^{T} - {( \frac{\partial T}{\partial s} )}^{T} = λ + {f}_{gen} \qquad ( Eq . 1 )$$

The constrained dynamic equation may be implemented to solve for the time-varying pose of the rigid bodies, s, corresponding velocities, s, and Lagrange multipliers, λ, so that a mechanical system is in dynamic equilibrium at all times t. Assuming non-conservative and conservative forces to be part of the generalized force term, f_{gen}, the Lagrangian is set to the kinetic energy T, omitting a potential energy term for conservative forces. To enforce a set of equality constraints, [symbol] =0, multipliers λ are chosen so that the generalized forces,

$$λ ,$$

do not do any work on the system, where [symbol] ₛ is the Jacobian of the constraints or their derivatives with respect to the pose.

Equation 2 represents the state of a single rigid body with the position of its center of mass, c, in global coordinates and its orientation with a unit quaternion q.

$$s = [ \begin{matrix}c \\ q\end{matrix} ] , together with corresponding velocities \dot{s} = [ \begin{matrix}v \\ w\end{matrix} ] . \qquad ( Eq . 2 )$$

The linear velocity of the rigid bodies is represented with v=ċ. The angular velocity of rigid bodies is represented with the time derivative of the quaternion, w=\dot{q}, instead of the angular velocity ω, for angular motion. Instead of utilizing a 13-dimensional set of state variables (c, q, v, ω), the representation utilizes a 14-dimensional set (c, q, v, w) and enforces the unit-length constraint, [symbol] =q^{T}q−1, explicitly.

Equations of motion of the body are derived by defining the kinetic energy of the body T=Tₗᵢₙ+T_{and} that is due to the linear and angular motion defined in Equation 3, where J_{rb} is the constant moment of inertia, rotated to global coordinates using the rotation matrix R(q). Matrix R(q) can be expressed with two matrices, G(q) and H(q), whose entries linearly depend on the coordinates of the unit quaternion, as described in Table 1 entries and row 6.

$$\begin{matrix}{T}_{lin} ( \dot{c} ) = \frac{1}{2} {\dot{c}}^{T} M \dot{c} & {T}_{ang} ( q , ω ) = \frac{1}{2} {ω}^{T} R ( q ) {J}_{rb} {R ( q )}^{T} ω\end{matrix} \qquad ( Eq . 3 )$$

Table 1 describes properties of matrices G(q), H(q), and R(q). The properties are numbered in the left column and used herein in derivations. As described herein, equations that use properties described in Table 1 in derivations are indicated with the property number(s) notated above the equal sign. Table 1 summarizes the entries and properties (1-5) of the individual matrices G(q) and H(q), and list properties that use a combination of them to express the rotation matrix (6), its time derivative (7, 8), and relate the angular velocity to the time derivative of the quaternion and vice versa (9, 10). The properties can be verified by substituting q=[qₓ q_{y} q_{z} q_{w}]^{T}, with the real part q_{w}, and by using the unit-length property, q^{T} q=1. I₃ and I₄ are 3D and 4D identity matrices and [a]ₓ is the skew-symmetric matrix form of the cross product of a with another vector.

TABLE 1

| | G(q) | H(q) |
|---|---|---|
| Entries | $[ \begin{matrix}{q}_{w} & - {q}_{z} & {q}_{y} & - {q}_{x} \\ {q}_{z} & {q}_{w} & - {q}_{x} & - {q}_{y} \\ - {q}_{y} & {q}_{x} & {q}_{w} & - {q}_{z}\end{matrix} ]$ | $[ \begin{matrix}{q}_{w} & {q}_{z} & - {q}_{y} & - {q}_{x} \\ - {q}_{z} & {q}_{w} & {q}_{x} & - {q}_{y} \\ {q}_{y} & - {q}_{x} & {q}_{w} & - {q}_{z}\end{matrix} ]$ |
| 1 | G(q)q = 0 | H(q)q = 0 |
| 2 | for v ∈ [symbol] : G(q)v = −G(v)q | for v ∈ [symbol] : H(q)v = −H(v)q |
| 3 | G(q)G(q)^{T} = I₃ | H(q)H(q)^{T} = I₃ |
| 4 | G(q)^{T}G(q) = −qq^{T} + I₄ | H(q)^{T}H(q) = −qq^{T} + I₄ |
| 5 | G(\dot{q})\dot{q} = 0 | H(\dot{q})\dot{q} = 0 |

| | |
|---|---|
| 6 | R(q) = G(q)H(q)^{T} |
| Entries | $[ \begin{matrix}{q}_{w}^{2} + {q}_{x}^{2} - {q}_{y}^{2} - {q}_{z}^{2} & 2 {q}_{x} {q}_{y} - 2 {q}_{w} {q}_{z} & 2 {q}_{w} {q}_{y} + 2 {q}_{x} {q}_{z} \\ 2 {q}_{w} {q}_{z} + 2 {q}_{x} {q}_{y} & {q}_{w}^{2} - {q}_{x}^{2} + {q}_{y}^{2} - {q}_{z}^{2} & 2 {q}_{y} {q}_{z} - 2 {q}_{w} {q}_{x} \\ 2 {q}_{x} {q}_{z} - 2 {q}_{w} {q}_{y} & 2 {q}_{w} {q}_{x} + 2 {q}_{y} {q}_{z} & {q}_{w}^{2} - {q}_{x}^{2} - {q}_{y}^{2} + {q}_{z}^{2}\end{matrix} ]$ |
| 7 | G(q)H(\dot{q})^{T} = G(\dot{q})Hq)^{T} |
| 8 | \dot{R} = R(\dot{q}) [symbol] 2G(q)H(\dot{q})^{T} [symbol] 2G(\dot{q})H(q)^{T} |
| 9 | [ω]_{×} = RR^{T} = [symbol] 2G(\dot{q})H(q)^{T}H(q)G(q)^{T} [symbol] 2G(\dot{q})G(q)^{T} |
| 10 | $ω 2 G ( q ) \dot{q} ⇔ \dot{q} {=}^{3} \frac{1}{2} {G ( q )}^{T} ω$ |

For the linear motion of a body, the Euler-Lagrange equations result in Newton's second law with external forces f ∈ [symbol] that act on the body's center of mass as described with Equation 4.

$$\frac{d}{dt} {( \frac{\partial {T}_{lin}}{\partial \dot{c}} )}^{T} - {( \frac{\partial {T}_{lin}}{\partial c} )}^{T} = M \ddot{c} = M \dot{v} = f \qquad ( Eq . 4 )$$

The Euler-Lagrange equations for the angular motion of the body described in Equation 5 have a less trivial right-hand side, because the derivative of the unit-length constraint is non-zero and the external torque around the center of mass, t, needs to be transformed to the 4D space by applying the transformation 2G(q)^{T}. The particular form of this transformation can be traced back to the relationship between the angular velocity and the time derivative of the quaternion.

$$\frac{d}{dt} {( \frac{\partial {T}_{ang}}{\partial \dot{q}} )}^{T} - {( \frac{\partial {T}_{ang}}{\partial q} )}^{T} = {𝒞}_{q}^{T} λ + 2 {G ( q )}^{T} τ \qquad ( Eq . 5 )$$

Equation 6 describes two derived variants of kinetic energy that only depend on the quaternion and its time derivative. The numbers above the equal sign indicates which properties of Table 1 are used in the derivation and the order which the properties are applied.

$${{T}_{ang} ( q , \dot{q} )}^{6 , 10 , 3} = 2 {\dot{q}}^{T} {H ( q )}^{T} {J}_{r b} H ( q ) \dot{q} {=}^{2} 2 {q}^{T} {H ( \dot{q} )}^{T} {J}_{r b} H ( \dot{q} ) q \qquad ( Eq . 6 )$$

Equation 7 describes the derived 4D Euler-Lagrange equations for angular motion.

$${H ( q )}^{T} {J}_{r b} H ( q ) \ddot{q} + 8 {H ( \dot{q} )}^{T} {J}_{r b} H ( q ) \dot{q} = 2 q λ + 2 {G ( q )}^{T} τ . \qquad ( Eq . 7 )$$

$$\frac{1}{2} G ( q ) ,$$

The equations are projected to the 3D space by multiplying either side with

to simplify the right-hand side, as described in Equation 8.

$$2 G ( q ) {H ( q )}^{T} {J}_{r b} H ( q ) \ddot{q} + 4 G ( q ) {H ( \dot{q} )}^{T} {J}_{r b} H ( q ) \dot{q} = τ \qquad ( Eq . 8 )$$

As described in Equation 9, the generalized force due to the unit-length constraint cancels. The Lagrange multiplier can therefore be ignored, resulting in the first-order system with 14 equations in 14 unknown state variables c, q, v, w that is in equilibrium if equations F1-F5 evaluate to zero. Because the last equation does not depend on the time derivative of a state variable, the system consists of a set of DAEs and not only ordinary differential equations (ODEs).

$$[ \begin{matrix}F 1 \\ F 2 \\ F 3 \\ F 4 \\ F 5\end{matrix} ] = [ \begin{matrix}\dot{c} & - & v \\ \dot{q} & - & w \\ M \dot{v} & - & f \\ 2 R ( q ) {J}_{rb} H ( q ) \dot{w} & + & 4 G ( q ) {H ( w )}^{T} {J}_{rb} H ( q ) w - τ \\ & & {q}^{T} q - 1\end{matrix} ] = 0 \qquad ( Eq . 9 )$$

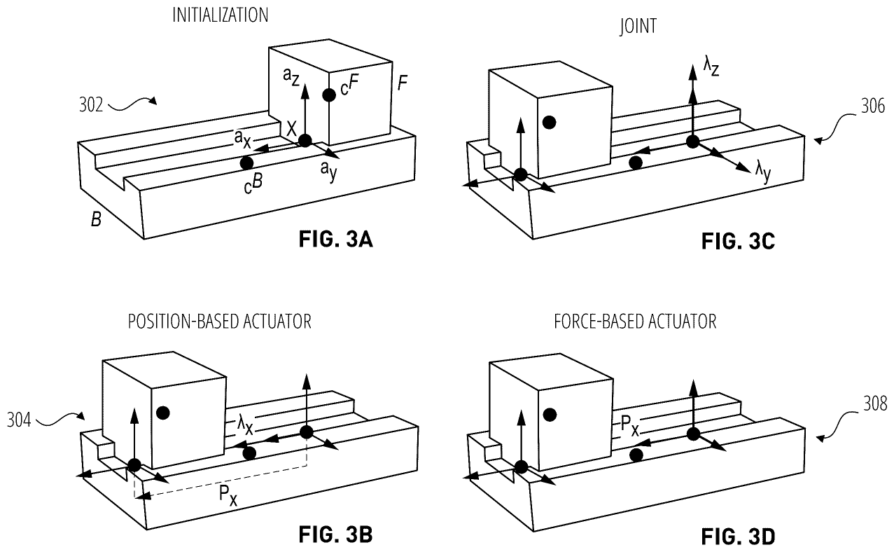

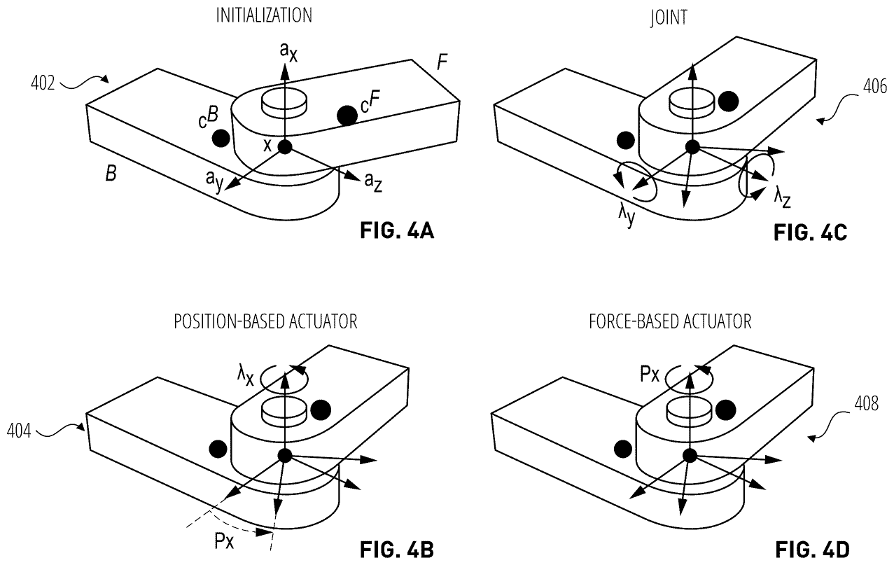

In operation 208, the dynamics optimization system 102 generates a kinematic constraint on the motion of a robotic component of the robotic device 112. The kinematic constraint may constrain the motion of the robotic component based on a dynamic characteristic of the robotic component, such that the forces acting on the robotic component do not exceed a dynamic tolerance. As used herein, a dynamic tolerance represents maximum force and/or degree-of-freedom thresholds that a robotic component can tolerate, based on characteristics of the robotic component. For example, the dynamics optimization system 102 may determine a dynamic tolerance of a joint based on the maximum threshold torque that the joint may bear. The kinematic constraint may constrain the motion of a joint such that the torque applied to the joint does not exceed the dynamic tolerance of the joint. In another example, the kinematic constraint may constrain the movement of a joint such that the rotational movement of the joint does not exceed the maximum degrees of freedom allowed by the joint. The kinematic constraint may include a rotational constraint on a rotational motion of the robotic component (e.g., a rotational motion as portrayed in FIGS. 4A-4D) and/or a translational constraint on a translational motion of the robotic component (e.g., a translational motion as portrayed in FIGS. 3A-3D). Additionally, the kinematic constraint may be an active constraint restricting active forces applied by the robotic component (e.g., applied by an actuator) and/or a passive constraint restricting forces applied upon the robotic component.

The kinematic constraints for the mechanical joints and position-based actuators of the robotic device 112 are based on the kinematic model 118 and may incorporate constraints of the kinematic design of the robotic device 112. Additionally, in the context of a dynamics model 128, the kinematic constraints are adjusted so that Lagrange multipliers consistently represent forces and torques in joint coordinates of a follower body F and a base body B. The kinematic constraints may also include constraints based on a force-based actuator for every position-based actuator.

To generate the kinematic constraint, the dynamics optimization system 102 may define joint and body coordinates of the robotic component. To formulate constraints between a follower body F and a base body B, the initial location of a joint, x, as well as its axes, A=[aₓ, a_{y}, a_{z}], is defined in global coordinates (e.g., as portrayed in initialization phase 302 of FIG. 3A and initialization phase 402 of FIG. 4A). By setting the orientations of all bodies to the identity at time t=0, the joint axes in local body coordinates equal the global axes,

$${A}_{rb}^{F} = {A}_{rb}^{B} = A ,$$

and the joint location in body coordinates are

x_{rb}^{F}=x−c^{F}

and

x_{rb}^{B}=x−c^{B}.

The kinematic constraint between the follow body and base body consist of up to three translational and up to three rotational constraints, [symbol] (c^{F}, q^{F}, c^{B}, q^{B})=0, dependent on the degrees of freedom. To enforce a constraint, the dynamics optimization system 102 may introduce a Lagrange multiplier λ, and add the constraint forces and torques,

$${f}^{F} = {C}_{{c}^{F}}^{T} λ , {f}^{B} = {𝒞}_{{c}^{B}}^{T} λ , {τ}^{F} = \frac{1}{2} G ( {q}^{F} ) {𝒞}_{{q}^{F}}^{T} λ , and {τ}^{B} = \frac{1}{2} G ( {q}^{B} ) {𝒞}_{{q}^{B}}^{T} λ$$

to the equations of motion of the respective bodies.

In some examples, the kinematic constraint may include a passive translational constraint constraining a passive translational motion, e.g., as portrayed with respect to FIGS. 3A-3D. As portrayed in initialization phase 302 of FIG. 3A, translational motion may be defined along an axis aₓ. To generate a passive translational constraint along axis aₓ, the dynamics optimization system 102 may transform the difference, d, between the two global joint locations to body coordinates of the base and then to joint coordinates

$$= a \cdot ( R {( {q}^{B} )}^{T} d ) , d = R ( {q}^{F} ) {x}_{r b}^{F} + {c}^{F} - ( R ( {q}^{B} ) {x}_{r b}^{B} + {c}^{B} ) .$$

In some examples, the constraint forces and torques may be equal and opposite. Because the forces act at the joint location on the follower body, the forces induce constraint torques (moment arm times force). In some examples, the forces not equal and opposite, because the two moment arms are different. In some examples, the Lagrange multiplier represents the force along the positive axis a on the base body. As portrayed in joint 306 of FIG. 3C, for a prismatic joint with a degree of freedom along aₓ, the dynamics optimization system 102 may generate two translational constraints with a set to a_{y} and a_{z}. The corresponding Lagrange multipliers, λₓ and λ_{z}, transfer forces along the two constrained axes, but not along aₓ.

In some examples, the kinematic constraint may include an active translational constraint constraining an active translational motion, e.g., as portrayed with respect to FIGS. 3A-3D. As portrayed in initialization phase 302 of FIG. 3A, to control the position along axis a on body B with a parameter p, the dynamics optimization system 102 may subtract p from the passive constraint

C=α·(R(q^{B})^{T}d)−p.

Due to the linear dependence on p, the constraint forces and torques may be the same for an active and a passive version of this atomic constraint. The active translational constraint may constrain an active translational motion (e.g., a motion generated by an actuator). As portrayed in position-based actuator 304 of FIG. 3B, to turn a prismatic joint into a position-based actuator the dynamics optimization system 102 may add an active constraint with a set to aₓ and the position parameter pₓ, in addition to the two passive constraints. Once p is set, the translational motion may be fully constrained and forces in all directions may be transferred.

To represent active translational forces, instead of controlling the position along the axis α (e.g., as portrayed in FIG. 3A) by adding an active constraint, the dynamics optimization system 102 may replace the multiplier in the constraint forces for body F with a force variable p, where f^{F}=R(a^{B})ap, resulting in two actuation forces that in turn induce two torques. As portrayed with force-based actuator 308 of FIG. 3D, to turn a prismatic joint into a force-based actuator the dynamics optimization system 102 may add a pair of actuation forces and corresponding torques with a set to aₓ and pₓ representing the actuation force along aₓ, but the dynamics optimization system 102 may not add a constraint.

In some examples, the kinematic constraint may include a passive rotational constraint constraining a passive rotational motion. To restrict rotational motion, the dynamics optimization system 102 may restrict an axis α on the follower to remain orthogonal to another axis b on the base described in Equation 10.

$$C = \pm ( R ( {q}^{F} ) a ) \cdot ( R ( {q}^{B} ) b ) \qquad ( Eq . 10 )$$

Because the constraint does not depend on the two centers of mass, the two constraint torques may be non-zero

τ^{F}=±(R(q^{F})a×R(q^{B})b)λ,τ^{B}=−τ^{F}.

The two torques may be equal and opposite, and the dynamics optimization system 102 may interpret the Lagrange multiplier as torque about the axis that is perpendicular to both R(q^{F})a and R(q^{B})b. For consistency with the translational constraints, the dynamics optimization system 102 may define the two axes and the sign so that A represents a positive torque about the axis ±R(q^{B})(a×b) on the base body. For example, as portrayed with reference to joint 406 of FIG. 4C, for a revolute joint with axis aₓ, the dynamics optimization system 102 may define the pair (a, b) to (aₓ, a_{z}) for a first constraint with a minus sign, and to (aₓ, a_{y}) for a second constraint with a plus sign. The reason is that, at the solution, the first multiplier, λ_{y}, represents a torque about a_{y} and the second multiplier, λ_{z}, a torque about a_{z} on the base body.

Table 2 describes properties of constraint derivatives which may be used to derive translational and rotational constraints.

TABLE 2

| | C(q) | $\frac{1}{2} G ( q ) {C}_{q}^{T} λ$ |
|---|---|---|
| 1 | a·(R(q)b) | (R(q)b) × (aλ) |
| 2 | a·(R(q)^{T}b) | b × (−R(q)aλ) |
| 3 | (R(q)a)·b | (R(q)a × b)λ |
| 4 | a·(R(q)b) | −(a × R(q)b)λ |

In some examples, the kinematic constraint may include an active rotational constraint constraining an active rotational motion. In some examples, to control the rotation about the axis a×b by angle p, the dynamics optimization system 102 may either rotate a on the follower

C=±(R(q^{F})R[p,a×b]^{T}a)·(R(q^{B})b)

or rotate b on the base body

C=±(R(q^{F})a).(R(q^{B})R[p,a×b]b)

before defining the two axes to remain orthogonal. Because p may represent a positive rotation about a×b on the base body, the dynamics optimization system 102 may transpose the rotation R[p, a×b] in the first constraint. To turn a revolute joint into a position-based actuator (e.g., as portrayed by position-based actuator 404 of FIG. 4B), the dynamics optimization system 102 may use the first variant of the constraint, defining the pair (a, b) to (a_{y}, a_{z}), with angle pₓ representing a rotation about

aₓ=a_{y}×a_{z}

on the base body. Because a universal joint is may be a three body joint with a star-shaped mid-body, the dynamics optimization system 102 may utilize both variants to define an actuator.

In some examples, as an alternative to an active rotational constraint, the kinematic constraint may include actuation torques, such as an active rotational torque represented by

τ_{F}=±R(q^{B})(a×b)p,τ^{B}=−τ^{F}

to model torque-based actuators. p represents a torque in local joint coordinates on body B about the axis a×b. For example, for a force-based revolute actuator (e.g., as portrayed by force-based actuator 408 of FIG. 4D) with axis aₓ, the follower torque is

τ_{F}=±R(q^{B})aₓpₓ

where pₓ represents the torque about the revolute axis.

In some examples, the dynamics optimization system 102 may combine one or more kinematic constraints. As described in Table 3, by adding a constraint for each restricted translation or rotation, the dynamics optimization system 102 may model the degrees of freedom of a plurality of mechanical joints, turning them either into position-or force-based actuators if needed. Table 4 describes implementation-ready formulas for the translational and rotational constraints that are listed in Table 3.

TABLE 3

| Name | Translation Constraints | Rotation Constraints |
|---|---|---|
| Fixed | fixed | fixed |
| Prismatic | 1 DoF (aₓ) | fixed |
| Revolute | fixed | 1 Dof (aₓ) |
| Rectangular | 2 DoF (aₓ, a_{y}) | fixed |
| Cylindrical | 1 DoF (aₓ) | 1 DoF (aₓ) |
| Pin in Slot | 1 DoF (aₓ) | 1 DoF (a_{y}) |
| Universal | fixed | 2 DoF(aₓ, a_{y}) |
| Cartesian | free | fixed |
| Planar | 2 DoF (aₓ, a_{y}) | 1 DoF (a_{z}) |
| Spherical | fixed | free |
| Slot | 1 DoF (aₓ) | free |
| Free | free | free |

TABLE 4
Translational Constraints

| | joints | | | 1 position-based actuators | | | force-based actuators | | |
|---|---|---|---|---|---|---|---|---|---|
| | C | [symbol] | [symbol] | C | [symbol] | [symbol] | C | [symbol] | [symbol] |
| fixed | $\begin{matrix}{r}_{x}^{B} \cdot d \\ {r}_{y}^{B} \cdot d \\ {r}_{z}^{B} \cdot d\end{matrix}$ | $\begin{matrix}+ {r}_{x}^{B} {λ}_{x} \\ + {r}_{y}^{B} {λ}_{y} \\ + {r}_{z}^{B} {λ}_{z}\end{matrix}$ | $+ {m}^{F} \times ( {r}_{x}^{B} {λ}_{x} ) \\ + {m}^{F} \times ( {r}_{y}^{B} {λ}_{y} ) \\ + {m}^{F} \times ( {r}_{z}^{B} {λ}_{z} )$ | ${r}_{x}^{B} \cdot d \\ {r}_{y}^{B} \cdot d \\ {r}_{z}^{B} \cdot d$ | $+ \text{?} \\ + {r}_{y}^{B} {λ}_{y} \\ + \text{?}$ | $+ {m}^{F} \times ( {r}_{x}^{B} {λ}_{x} ) \\ + {m}^{F} \times ( {r}_{y}^{B} {λ}_{y} ) \\ + {m}^{F} \times ( {r}_{z}^{B} {λ}_{z} )$ | ${r}_{x}^{B} \cdot d \\ {r}_{y}^{B} \cdot d \\ \text{?} \cdot d$ | $+ {r}_{x}^{B} {λ}_{x} \\ + {r}_{y}^{B} {λ}_{y} \\ + {r}_{z}^{B} {λ}_{z}$ | $+ {m}^{F} \times ( {r}_{x}^{B} {λ}_{x} ) \\ + {m}^{F} \times ( {r}_{y}^{B} {λ}_{y} ) \\ + {m}^{F} \times ( {r}_{z}^{B} {λ}_{z} )$ |
| 1 DoF | $\begin{matrix}{r}_{y}^{B} \cdot d \\ {r}_{z}^{B} \cdot d\end{matrix}$ | $\begin{matrix}+ {r}_{y}^{B} {λ}_{y} \\ + {r}_{z}^{B} {λ}_{z}\end{matrix}$ | $+ {m}^{F} \times ( {r}_{x}^{B} {λ}_{x} ) \\ + {m}^{F} \times ( {r}_{z}^{B} {λ}_{z} )$ | $\text{?} \cdot d - \text{?} \\ \text{?} \cdot d \\ \text{?} \cdot d$ | $+ {r}_{x}^{B} {λ}_{x} \\ + {r}_{y}^{B} {λ}_{y} \\ + {r}_{z}^{B} {λ}_{z}$ | $+ {m}^{F} \times ( \text{?} ) \\ + {m}^{F} \times ( {r}_{y}^{B} {λ}_{y} ) \\ + {m}^{F} \times ( {r}_{z}^{B} {λ}_{z} )$ | ${r}_{y}^{B} \cdot d \\ \text{?} \cdot d$ | $+ \text{?} \\ + {r}_{y}^{B} {λ}_{y} \\ + {r}_{z}^{B} {λ}_{z}$ | $+ {m}^{F} \times ( \text{?} ) \\ + {m}^{F} \times ( {r}_{y}^{B} {λ}_{y} ) \\ + {m}^{F} \times ( {r}_{z}^{B} {λ}_{z} )$ |
| 2 DoF | ${r}_{z}^{B} \cdot d$ | $+ {r}_{z}^{B} {λ}_{z}$ | $+ \text{?} \times ( \text{?} )$ | ${r}_{x}^{B} \cdot d - {p}_{x} \\ {r}_{y}^{B} \cdot d - {p}_{y} \\ {r}_{z}^{B} \cdot d$ | $+ \text{?} \\ + {r}_{y}^{B} {λ}_{y} \\ + {r}_{z}^{B} {λ}_{z}$ | $+ {m}^{F} \times ( {r}_{x}^{B} {λ}_{x} ) \\ + {m}^{F} \times ( {r}_{y}^{B} {λ}_{y} ) \\ + {m}^{F} \times ( {r}_{z}^{B} {λ}_{z} )$ | ${r}_{z}^{B} \cdot d$ | $+ {m}^{F} \times ( \text{?} ) \\ + {m}^{F} \times ( {r}_{y}^{B} {λ}_{y} ) \\ + {m}^{F} \times ( {r}_{z}^{B} {λ}_{z} )$ | $+ {m}^{F} \times ( {r}_{x}^{B} {p}_{x} ) \\ + {m}^{F} \times ( {r}_{y}^{B} {p}_{y} ) \\ + {m}^{F} \times ( {r}_{z}^{B} {λ}_{z} )$ |
| free | | | | $\text{?} \cdot d - \text{?} \\ {r}_{y}^{B} \cdot d - {p}_{y} \\ \text{?} \cdot d - {p}_{z}$ | $+ {r}_{x}^{B} {λ}_{x} \\ + {r}_{y}^{B} {λ}_{y} \\ + {r}_{z}^{B} {λ}_{z}$ | $+ \text{?} \times ( {r}_{x}^{B} {λ}_{x} ) \\ + \text{?} \times ( {r}_{y}^{B} {λ}_{y} ) \\ + \text{?} \times ( {r}_{z}^{B} {λ}_{z} )$ | | $+ {r}_{x}^{B} \text{?} \\ + {r}_{y}^{B} {p}_{y} \\ + {r}_{z}^{B} \text{?}$ | $+ {m}^{F} \times ( {r}_{x}^{B} {p}_{x} ) \\ + {m}^{F} \times ( {r}_{y}^{B} {p}_{y} ) \\ + {m}^{F} \times ( {r}_{z}^{B} {p}_{z} )$ |

Rotational Constraints

| | joints | | | position-based actuators | | | force-based actuators | | |
|---|---|---|---|---|---|---|---|---|---|
| | C | [symbol] | consist. C | C | [symbol] | consist. C | C | [symbol] | consist. C |
| fixed | $\text{?} \cdot {r}_{z}^{B} \\ \text{?} \cdot {r}_{x}^{B} \\ \text{?} \cdot {r}_{y}^{B}$ | $+ ( \text{?} \times {r}_{z}^{B} ) {λ}_{x} \\ + ( \text{?} \times \text{?} ) {λ}_{y} \\ + ( \text{?} \times {r}_{z}^{B} ) \text{?}$ | $\text{?} \cdot {r}_{x}^{B} \\ \text{?} \cdot {r}_{y}^{B} \\ \text{?} \cdot \text{?}$ | $\text{?} \cdot {r}_{z}^{B} \\ \text{?} \cdot {r}_{x}^{B} \\ \text{?} \cdot {r}_{y}^{B}$ | $+ ( \text{?} \times \text{?} ) {λ}_{x} \\ + ( \text{?} \times {r}_{x}^{B} ) {λ}_{y} \\ + ( \text{?} \times {r}_{y}^{B} ) {λ}_{z}$ | $\text{?} \cdot \text{?} \\ \text{?} \cdot {r}_{y}^{B} \\ \text{?} \cdot {r}_{z}^{B}$ | $\text{?} \cdot {r}_{z}^{B} \\ \text{?} \cdot {r}_{x}^{B} \\ \text{?} \cdot {r}_{y}^{B}$ | $+ ( \text{?} \times {r}_{z}^{B} ) {λ}_{x} \\ + ( \text{?} \times {r}_{x}^{B} ) {λ}_{y} \\ + ( \text{?} \times {r}_{y}^{B} ) {λ}_{z}$ | $\text{?} \cdot \text{?} \\ \text{?} \cdot {r}_{y}^{B} \\ \text{?} \cdot {r}_{z}^{B}$ |
| 1 DoF | $- \text{?} \cdot {r}_{z}^{B} \\ \text{?} \cdot {r}_{y}^{B}$ | $- ( \text{?} \times \text{?} ) {λ}_{y} \\ + ( \text{?} \times \text{?} ) {λ}_{z}$ | $\text{?} \cdot \text{?}$ | $\text{?} ( \text{?} ) \cdot \text{?} \\ - \text{?} \cdot {r}_{z}^{B} \\ \text{?} \cdot {r}_{y}^{B}$ | $\text{?} ( \text{?} ) \times \text{?} \\ - ( \text{?} \times {r}_{z}^{B} ) {λ}_{y} \\ + ( \text{?} \times {r}_{y}^{B} ) {λ}_{z}$ | $\text{?} \cdot \text{?} \\ \text{?} ( {p}_{x} ) \cdot {r}_{y}^{B} \\ \text{?} ( \text{?} ) \cdot \text{?}$ | $- \text{?} \cdot \text{?} \\ \text{?} \cdot {r}_{y}^{B}$ | $+ {r}_{x}^{B} {p}_{x} \\ - ( \text{?} \times \text{?} ) {λ}_{y} \\ + ( \text{?} \times {r}_{y}^{B} ) {λ}_{z}$ | $\text{?} \cdot {r}_{x}^{B}$ |
| 2 DoF | $- \text{?} \cdot \text{?}$ | $- ( \text{?} \times \text{?} ) \text{?}$ | | $\text{?} \cdot \text{?} ( {p}_{x} ) \\ \text{?} ( {p}_{y} ) \cdot {r}_{x}^{B} \\ - \text{?} \cdot \text{?}$ | $+ ( \text{?} \times \text{?} ( \text{?} ) ) {λ}_{x} \\ + ( \text{?} ( {p}_{y} ) \times {r}_{x}^{B} ) {λ}_{y} \\ - ( \text{?} \times \text{?} ) \text{?}$ | $\text{?} ( \text{?} ) \cdot \text{?} \\ \text{?} \cdot {\underline{r}}_{y}^{B} ( {p}_{x} ) \\ \text{?} ( {p}_{y} ) \cdot {\underline{r}}_{z}^{B} ( {p}_{x} )$ | $- \text{?} \cdot {r}_{x}^{B}$ | $\text{?} {p}_{x} \\ + {r}_{y}^{B} {p}_{y} \\ - ( \text{?} \times {r}_{x}^{B} ) {λ}_{z}$ | |
| free | | | | $\text{?} ( p ) \cdot {r}_{z}^{B} \\ \text{?} ( p ) \cdot {r}_{x}^{B} \\ \text{?} ( p ) \cdot {r}_{y}^{B}$ | $+ ( \text{?} ( p ) \times \text{?} ) {λ}_{x} \\ + ( \text{?} ( p ) \times {r}_{x}^{B} ) {λ}_{y} \\ + ( \text{?} ( p ) \times {r}_{y}^{B} ) {λ}_{z}$ | $\text{?} ( p ) \cdot {r}_{x}^{B} \\ \text{?} ( p ) \cdot {r}_{y}^{B} \\ \text{?} ( p ) \cdot {r}_{z}^{B}$ | | $+ \text{?} \\ + \text{?} {p}_{y} \\ + {r}_{z}^{B} \text{?}$ | |

[symbol]

indicates data missing or illegible when filed

In some examples, the dynamics optimization system 102 may utilize atomic constraints to partially actuate a mechanical joint, or mix position-and force-based actuation along or about axes.

In some examples, the dynamics optimization system 102 may generate a unary kinematic constraint. By setting the center of mass of the base body to zero and its orientation to the identity, the dynamics optimization system 102 may modify a kinematic constraint into one that constrains a follower body to the world.

For joints and actuators with more than one orthogonality constraint, the dynamics optimization system 102 may generate kinematic constraints with flipped axes. The dynamics optimization system 102 may utilize solvers to converge to a “flipped” solution if large steps are taken. For instance, for a revolute joint, both solutions

R(q^{F})aₓ=±R(q^{B})aₓ

satisfy the two constraints. To prevent flips, the dynamics optimization system 102 may formulate consistency constraints, which evaluate to 1 for the correct solution, and 0 or −1 for extraneous solutions. When solving the equations of motion, during line search, the dynamics optimization system 102 may backtrack if any consistency constraint is below a positive threshold. For example, for a revolute joint with axis aₓ, the dynamics optimization system 102 may introduce one consistency constraint by setting a=b=aₓ in Equation 10.

In operation 210, the dynamics optimization system 102 generates a dynamics model 128 of the robotic device 112 based on the motion representation and kinematic constraint. The dynamics optimization system 102 may integrate the constraints to generate constrained dynamics representing the robotic device 112. For example, the dynamics optimization system 102 may apply the kinematic constraint to an equation of motion of a robotic component of the robotic device 112 dynamics model 128 of a motion of the robotic component, where the motion is constrained by the kinematic constraint. In this manner, the dynamics optimization system 102 may generate a dynamics model 128 of the robotic component that accounts for a dynamic characteristic of the robotic component. For example, the dynamics model 128 of an arm of an animatronic character may describe a motion of the arm such that the active and/or passive forces acting on the arm do not exceed the force limits of the arm and/or the force capabilities of an actuator acting on the arm. In some examples, the dynamics model 128 may describe a motion retargeted from the target animation data 120, and may include a motion representation for a plurality of bodies of the robotic device 112, such as a continuous equation of motion for each body of the robotic device 112. Further, the dynamics optimization system 102 may include a solver configured to solve the continuous equations of motion to generate a simulation the motion of the robotic component for the dynamics model 128 of the robotic device 112.

The dynamics optimization system 102 may form the continuous equations of motion for a multibody system, F(y, y, t)=0, by first adding the equations of motion for the individual bodies, followed by adding constraints C. For every constraint, the dynamics optimization system 102 may add a Lagrange multiplier to y and subtract corresponding constraint forces and torques from the respective body equations. F=0 constitutes a system of DAEs of index 3 and Hessenberg form, which the dynamics optimization system 102 may integrate forward in time with a fully implicit scheme, such that kinematic constraints can be enforced up to a numerical tolerance, and to ensure unconditional stability, which is valuable when solving optimization problems with a simulator in the loop. The dynamics optimization system 102 may utilize two families of methods for the implicit integration of DAEs, backward differentiation formula (BDF) methods, and implicit Runge-Kutta methods.

In some examples, the dynamics optimization system 102 may implicitly integrate DAEs applying a BDF method with a fixed time step Δt. Given a linear combination of previous states,

yₚ:=a₁y^{(k-1)}+ . . . +aₘy^{(k-m)}

the next state yₙ:=y^{(k)} at time tₙ:=kΔt is computed as the solution of the system described with Equation 11 which is solved with an iterative Newton-type solver.

$$F ( \frac{{y}_{n} - {y}_{p}}{βΔ t} , {y}_{n} , {t}_{n} ) = 0 \qquad ( Eq . 11 )$$

Variables β, α₁, . . . , αₘ are tabulated coefficients for the BDF formula of order m. An advantage of discretizing with a BDF formula is that the cost of solving Equation 11 is largely independent of the order m, as it only affects the precomputation of yₚ. However, in some examples, formulas of order 3 or higher are not unconditionally stable. The usage of a fixed time step Δt may be required for convergence, which may prevent the use of adaptive time-stepping schemes, or may require additional correction. Therefore, in some examples, the dynamics optimization system 102 may preferably utilize a first BDF (β=1, α₁=1) (BDF1) and a

$$second BDF ( β = \frac{2}{3} , {α}_{1} = \frac{4}{3} , {α}_{2} = \frac{1}{3} ) ( BDF 2 )$$

and find the latter a good trade-off between computational cost, accuracy, and stability. The fixed time step may also facilitate downstream processing of the simulation results, including differentiating through a simulation sequence for sensitivity analysis or optimization.

In some examples, the dynamics optimization system 102 may implicitly integrate DAEs applying an implicit s-stage Runge-Kutta method, if a higher-order method or adaptive time-stepping are desired. To apply the Runge-Kutta method, the dynamics optimization system 102 may solve Equation 12 for k₁, . . . , kₛ and y^{(k)} at

tₖ=tₖ₋₁+Δt,

given the previous state y^{(k-1)} at tₖ₋₁.

$$\{ \begin{matrix}{y}^{( k )} = {y}^{( k - 1 )} + Δ t {\sum }_{i = 1}^{s} {b}_{i} {k}_{i} \\ F ( {k}_{i} , {y}^{( k - 1 )} + Δ t {\sum }_{j = 1}^{s} {a}_{ij} {k}_{j} , {t}_{k - 1} + {c}_{i} Δ t ) = 0 , i = 1 … s\end{matrix} \qquad ( Eq . 12 )$$

Coefficients aᵢⱼ, bᵢ, and cᵢ may be scheme-specific. Assuming a diagonally implicit Runge-Kutta (DIRK) method, that is, aᵢⱼ=0 for i<j, the dynamics optimization system 102 may compute intermediate solutions kᵢ sequentially, applying an algebraic solver s times to solve Equation 13 for the intermediate state yᵢ, from which the dynamics optimization system 102 may then recover kᵢ as described in Equation 14.

$$F ( \frac{{y}_{i} - ( {y}^{( k - 1 )} + Δ t {\sum }_{j = 1}^{i - 1} {a}_{i j} {k}_{j} )}{{a}_{i i} Δ t} , {y}_{i} , {t}_{k - 1} + {c}_{i} Δ {t}_{i} ) = 0 \qquad ( Eq . 13 )$$

$${k}_{i} = \frac{{y}_{i} - ( {y}^{( k - 1 )} + Δ t {\sum }_{j = 1}^{i - 1} {a}_{i j} {k}_{j} )}{{a}_{i i} Δ t} \qquad ( Eq . 14 )$$

The discretized Equation 13 and Equation 11 may be the same where the dynamics optimization system 102 sets the unknown state yₙ in Equation 13 to y; and the aggregated previous state

$${y}_{p} to {y}^{( k - 1 )} + Δ t {\sum }_{j = 1}^{i - 1} {a}_{ij} {k}_{j} .$$

The dynamics optimization system 102 may therefore use the same solution strategy to solve them. DIRK methods may not fulfill algebraic constraints at the new state y^{(k)}, unless the method is stiffly-accurate, which may require that cₛ=1 and aₛᵢ=bᵢ for i=1, . . . , s. For systems where energy conservation is of secondary importance, using the BDF2 integration with a smaller time step may be preferable over a DIRK method, as the higher order of convergence does not offset the additional computational cost. In addition, implicit Runge-Kutta methods may yield a strictly lower order of convergence when used for DAE integration as opposed to ODE integration. Therefore, the dynamics optimization system 102 may limit the use of Runge-Kutta methods to validations, and to improve the start-up of the BDF2 by integrating the first step using a stiffly-accurate two-stage SDIRK method with coefficients described in Table 5.

TABLE 5

$\begin{matrix}\begin{matrix}1 - \frac{\sqrt{2}}{2} \\ 1\end{matrix} & \begin{matrix}1 - \frac{\sqrt{2}}{2} & 0 \\ \sqrt{2} - 1 & 1 - \frac{\sqrt{2}}{2}\end{matrix} \\ & \begin{matrix}\sqrt{2} - 1 & 1 - \frac{\sqrt{2}}{2}\end{matrix}\end{matrix}$

In some embodiments, the Runge-Kutta coefficients may be provided using a Butcher tableau, as portrayed in Table 6.

TABLE 6

$\begin{matrix}\begin{matrix}{c}_{1} \\ ⋮ \\ {c}_{s}\end{matrix} & \begin{matrix}\text{?} & … & {a}_{1 s} \\ ⋮ & ⋱ & ⋮ \\ {a}_{s 1} & … & {a}_{ss}\end{matrix} \\ & \begin{matrix}{b}_{1} & … & {b}_{s}\end{matrix}\end{matrix}$

In some embodiments, the DIRK method may be a Pareschi-Russo DIRK method with coefficients described in Table 7.

TABLE 7

$\begin{matrix}\begin{matrix}1 - \frac{\sqrt{2}}{2} \\ \frac{\sqrt{2}}{2}\end{matrix} & \begin{matrix}1 - \frac{\sqrt{2}}{2} & 0 \\ \sqrt{2} - 1 & 1 - \frac{\sqrt{2}}{2}\end{matrix} \\ & \begin{matrix}\frac{1}{2} & & & \frac{1}{2}\end{matrix}\end{matrix}$

The implicit integrator method of the dynamics optimization system 102 may simplify the computation of simulation derivatives with respect to arbitrary parameters, since no stabilization, or adaptive time-stepping, which would complicate differentiation, are required. Because the dynamics optimization system 102 utilizes additive instead of multiplicative quaternion updates, symbolic differentiation is directly applicable to all building blocks. The dynamics optimization system 102 may compute derivatives for all cases discussed herein, including over-actuation and redundant constraint subspaces.

In some examples, the dynamics optimization system 102 may include a solver configured to solve the discretized equations of the representations of motion to generate a simulation of a motion of the robotic device 112 for the dynamics model 128 of the robotic device 112. To step the simulator in time, the dynamics optimization system 102 may solve the discretized equations iteratively up to a numerical tolerance. The solver largely may follow a Newton scheme, refining a solution in steps by evaluating the equations F and their Jacobian F_{y}_{ₙ} at the current iterate yₙ, and computing an update Δ_{y}_{ₙ} by solving Equation 15.

$${F}_{{y}_{n}} Δ {y}_{n} = - F \qquad ( Eq . 15 )$$

For robustness, the dynamics optimization system 102 may perform a line search to select the next iterate along the direction Δ_{y}_{ₙ}, ensuring sufficient progress and preventing violations in consistency constraints. In some examples, there may be as many equations as unknowns by construction: For every rigid body, the dynamics optimization system 102 may add 14 equations in 14 unknowns, and for every constraint, the dynamics optimization system 102 may add as many constraint equations as unknown Lagrange multipliers. For most systems, however, the Jacobian may be poorly conditioned or rank-deficient. The latter occurs whenever kinematic constraints are redundant.

The dynamics optimization system 102 may utilize multiple adaptations to the iterative solver procedure, such that the discretized equations can be solved accurately for all classes of systems, including under-, fully-, and over-actuated systems, and/or systems with redundant kinematic constraints. As used herein, sₙ, sₙ, λₙ denotes the segments of yₙ corresponding to the collection of rigid body poses, velocities, and Lagrange multipliers, respectively.

In one adaptation, the dynamics optimization system 102 may apply system conditioning for small time steps. Even in the case of a full-rank Jacobian, the condition number of F_{y}_{ₙ} may grow quickly, with O(1/Δt⁴), when the time step is decreased. Therefore, the dynamics optimization system 102 may scale the rows and columns of the Jacobian. The dynamics optimization system 102 may define scaled versions of the variables, y′n:=D_{y}yₙ, and of the equations, F′:=D_{F}F, where D_{y}, D_{F} are diagonal matrices. The equivalent Newton step in the scaled variables is then D_{F}F_{yn}D_{y}⁻¹Δy′ₙ=−F′. By an appropriate choice of the scaling, the dominant terms in the condition number of the scaled Jacobian D_{F} F_{yn} D_{y}⁻¹ can be made independent of Δt. The dynamics optimization system 102 may set entries of D_{y}, Dₙ to (1) 1 if they correspond to position or orientation variables, or to unit-length or kinematic constraint equations; (2) Δt if they correspond to linear and angular velocity variables, or to velocity equations; (3) Δt 2 if they correspond to Lagrange multipliers, or to equilibrium equations (since forces scale like accelerations). The next iterate in the original variables is then recovered after the Newton step by applying the inverse scaling. As described herein, variables, equations and Jacobians may be scaled, but may not be described with the additional notation for simplicity.

In some examples, the dynamics model 128 of the robotic device 112 may be over-constrained with kinematic constraints. Systems with kinematic loops may display redundancy in their constraints; for example, a regular planar four-bar linkage with all-revolute joints may have 3 constraints more than necessary. Redundant constraints may manifest as redundant Lagrange multipliers, resulting in a subspace of solutions in terms of generalized forces transmitted at joints or actuators. For example, regarding a door pivoting about two hinges on the same axis, the weight of the door may be carried equally by both hinges, or a single hinge, or any intermediate distribution.

In some examples, the dynamics optimization system 102 may eliminate redundant kinematic constraints in the dynamics model 128 of the robotic device 112. When redundant kinematic constraints are present, the Jacobian, F_{y}_{ₙ}, becomes rank-deficient. The system described by Equation 31 may become both over-constrained (due to redundant constraints) and under-constrained (due to the subspace in the Lagrange multipliers), and can therefore not be directly solved for a least-squares (via F_{y}_{ₙ}^{T}F_{y}_{ₙ}) or least-norm (via F_{y}_{ₙ}F_{y}_{ₙ}^{T}) solution. An expensive rank-revealing solver, e.g., QR or singular value decomposition, would be required instead. To circumvent this, the dynamics optimization system 102 may determine a subset of kinematic constraints that can be eliminated while preserving the kinematics of the system of the robotic device 112. By also eliminating the corresponding multipliers, the dynamics optimization system 102 may obtain a reduced, full-rank system, which permits a more efficient solver; the dynamics optimization system 102 may use a sparse lower-upper (LU) decomposition. A more expensive singular value decomposition is required only for the redundancy analysis as a precomputation. For some systems, the set of removable constraints may vary over time, in particular close to a singularity. The dynamics optimization system 102 may remedy this by checking, at the end of each simulation step of the reduced system, that the eliminated constraints are still satisfied within a tolerance. If they are not, the dynamics optimization system 102 may perform a new redundancy analysis at the current state. In some examples, this occurs rarely and does not significantly affect performance. For increased robustness, the number of constraints to eliminate is stored after the first analysis, as numerical rank computations may be unreliable near singular configurations.

In some examples, the robotic device 112 may be an over-actuated system. Over-actuated systems contain more actuators than the degrees of freedom of the equivalent system with all passive joints. This can be used, for example, to distribute a load across multiple actuators. As a consequence, when performing position control, actuators cannot be stepped individually without violating the constraints-rather, they must move in concert. To accommodate this, the dynamics optimization system 102 may treat redundant actuators similarly to redundant constraints. In the case of redundant force-based actuators, no special treatment is required: the force inputs for these actuators only appear on the right-hand side of the system described with Equation 15, and thus do not affect its rank. When analyzing kinematic constraints, these actuators are treated like their corresponding passive joints.

In some examples, the dynamics optimization system 102 may utilize a weighted least-norm solution. As discussed, over-constrained systems exhibit a redundancy in their Lagrange multipliers. Using a reduced system may remove the redundancy by allowing only a subset of multipliers to be non-zero, but results in an arbitrary solution, with discontinuities if the set of reduced constraints needs to be updated. We note that only the equilibrium equations, corresponding to rigid body equations with added constraint forces, depend, linearly, on multipliers λₙ; thus the more general solution subspace is characterized by E_{λ}_{ₙ}λₙ=−E where E, E_{λ}_{ₙ}, are evaluated for λₙ=0 and sₙ, sₙ set as per the solution for the reduced system. To select a more meaningful and time-consistent solution within this subspace, the dynamics optimization system 102 may receive a user input (e.g., an input from the user 126 via the user interface 108) specifying a fixed weight wᵢ=0 for each force or torque component λᵢ. As a post-processing step, the dynamics optimization system 102 may solve for λₙ by minimizing the weighted norm

$$\frac{1}{2} {\sum }_{i} {w}_{i} {λ}_{i}^{2} ,$$

which admits a closed form described by Equation 16 where W:=diag ( . . . wᵢ . . . ), and the + exponent denotes the Moore-Penrose pseudo-inverse.

$${λ}_{n} = - {W}^{- 1} {{E}_{{λ}_{n}}^{T} ( {E}_{{λ}_{n}} {W}^{- 1} {E}_{{λ}_{n}}^{T} )}^{+} E \qquad ( Eq . 16 )$$

For systems without unconstrained degrees of freedom, this may be a regular inverse, and the system can be solved efficiently with a sparse Cholesky (LL^{T}) decomposition. Otherwise, a sparse QR solver can be employed. In some examples, where only trajectories of the system (i.e. values of s and s) are of interest to the user 126, this step may be omitted, keeping the reduced multipliers only, as future time steps are not influenced by Lagrange multipliers. Since the Lagrange multipliers in the formulation have a simple interpretation, the user 126 can intuitively set weights wᵢ. For instance, if minimal actuator torques are desired, the user 126 may set wᵢ=10⁵ for multipliers corresponding to position-controlled actuator torques, and wᵢ=1 for other forces and torques. Alternatively, weights could be chosen based on the relative compliance (inverse stiffness) of each joint to model the load distribution effect that compliance has in real mechanisms.

In some examples, the solver of the dynamics optimization system 102 is applicable for the general case of systems with potential unconstrained degrees of freedom. In other examples, the solver of the dynamics optimization system 102 is applicable for fully-constrained systems, that is, robotic device 112 systems for which the pose of all bodies is fully determined by the kinematic constraints C(s). Fully-constrained systems may imply only position-based actuators. For such systems, the dynamics optimization system 102 may apply a more efficient two-step solver strategy, utilizing the fact that position and force variables can be decoupled. The dynamics optimization system 102 may first solve forward kinematics, computing sₙ in an iterative Gauss-Newton process with update step represented by Equation 17 where K (Sn) concatenates unit-quaternion constraints F5 and kinematic constraints C.

$${K}_{{s}_{n}}^{T} {K}_{{s}_{n}} Δ {s}_{n} = - {K}_{{s}_{n}}^{T} K \qquad ( Eq . 17 )$$

In the presence of redundant kinematic constraints, the kinematic Jacobian, Kₛ_{ₙ}, as opposed to the full Jacobian F_{y}_{ₙ}, is rank-deficient along its rows only and therefore Kₛ_{ₙ}^{T}Kₛ_{ₙ} is always full-rank for fully-constrained systems, so the redundancy analysis step can be omitted. The scaling process described herein may not be required, as Δt does not appear. The system described by Equation 17 can be solved efficiently with a sparse Cholesky (LL^{T}) decomposition. After solving the forward kinematics, the dynamics optimization system 102 may directly determine velocities as per equations F1-F2. The dynamics optimization system 102 may can compute the Lagrange multipliers, λₙ, in a single system solve as per Equation 16. or more simply with λₙ=−E_{λ}_{ₙ}⁻¹E if no redundancy is present.

In some embodiments, the simulation derivatives may be computed using an implicit function theorem, and an adjoint method may be utilized to increase the computation speed of the computations. For non-over-constrained systems (e.g., mechanical systems without redundancies), the dynamics optimization system 102 may apply an implicit function theorem described by Equation 18 to Equation 11 to obtain the sensitivity of the state yₙ at a given time step with respect to parameters p (e.g. initial state, control inputs, or design variables).

$$\frac{\partial {y}_{n}}{\partial p} = - {( \frac{\partial F}{\partial {y}_{n}} )}^{- 1} \frac{\partial F}{\partial p} \qquad ( Eq . 18 )$$

Equation 18 describes a partial derivative, expressing only the effect of p through a single simulation step. The full derivative

$$\frac{d {y}_{n}}{d p}$$

is obtained by the chain rule described by Equation 19.

$$\frac{d {y}_{n}}{d p} = \frac{\partial {y}_{n}}{\partial p} + \frac{\partial {y}_{n}}{\partial {y}_{p}} \frac{d {y}_{p}}{d p} \qquad ( Eq . 19 )$$

The single-step sensitivity

$$\frac{d {y}_{n}}{d p}$$

with respect to the aggregated previous state may be computed by setting p=yₚ in Equation 18; only the effect of sₚ, \dot{s}ₚ needs to be considered, as λₚ does not affect F. The derivative

$$\frac{d {y}_{p}}{d p}$$

is obtained as a linear combination of

$$\frac{d {y}^{( k - 1 )}}{d p} , \frac{d {y}^{( k - 2 )}}{d p} , … ,$$

with coefficients as per the chosen time integrator (e.g., BDF or Runge-Kutta).

For over-constrained systems (e.g., systems with redundant constraints), Equation 18 and Equation 19 must be applied to the reduced system without redundant kinematic constraints and corresponding multipliers. This may provide the sensitivities

$$\frac{d {s}_{n}}{d p} , \frac{{ds}_{n}^{\cdot }}{d p} ,$$

as sₚ, \dot{s}ₙ are identical for the full and reduced systems. In applications where the sensitivities

$$\frac{d {λ}_{n}}{d p}$$

are also required, the dynamics optimization system 102 may differentiate through the weighted least-norm solution described by Equation 16.

Setting G:=E_{λ}_{ₙ}W⁻¹E_{λ}_{ₙ}^{T}, the dynamics optimization system 102 may use the analytical derivative of the pseudo-inverse and remove terms that are always zero to obtain Equation 20 for x:=p, sₙ, \dot{s}ₙ, or \dot{s}ₚ, and where I is the identity matrix. Eₓ, E_{λ}_{ₙ}_{,x}^{T} are evaluated by the dynamics optimization system 102 with λ set to the multipliers computed for the reduced system, while E_{λ}_{ₙ} and E are evaluated with λ=0.

$$\frac{\partial {λ}_{n}}{\partial x} = - {W}^{- 1} {E}_{{λ}_{n}}^{T} {G}^{+} {E}_{x} - ( 1 - {W}^{- 1} {E}_{{λ}_{n}}^{T} {G}^{+} {E}_{{λ}_{n}} ) {W}^{- 1} {E}_{{λ}_{n} , x}^{T} {G}^{+} E \qquad ( Eq . 20 )$$

The pseudo-inverse G⁺ becomes an inverse if there are no unconstrained degrees of freedom. In some examples,

$$\frac{\partial {λ}_{n}}{\partial p}$$

may be zero. The second term in Equation 20 is zero for x=\dot{s}ₙ>\dot{s}ₚ. For x=sₙ, the term involves a 3rd-order tensor times a vector E_{λ}_{ₙ}_{,s}_{ₙ}^{T}G⁺ E which may be computed by finding the second derivative

$$\frac{{\partial }^{2} ( {E}^{T} v )}{\partial {λ}_{n} \partial {s}_{n}}$$

for a fixed vector v, and evaluating it for v=G⁺ E. The dynamics optimization system 102 may then obtain

$$\frac{d {λ}_{n}}{d p}$$

through the chain rule

$$\frac{d {λ}_{n}}{d p} = \frac{d {λ}_{n}}{d p} + \frac{d {λ}_{n}}{{ds}_{n}} \frac{{ds}_{n}}{d p} + \frac{d {λ}_{n}}{d {\dot{s}}_{n}} \frac{d {\dot{s}}_{n}}{d p} + \frac{d {λ}_{n}}{d {\dot{s}}_{p}} \frac{d {\dot{s}}_{p}}{d p} .$$

When the full sensitivity matrix

$$\frac{d {y}^{( k )}}{d p}$$

is not needed in itself, but only as part of a chain rule, the dynamics optimization system may use an adjoint method for more efficient computations. In particular, to solve an optimization problem around a simulation sequence, the dynamics optimization system 102 may only need to compute the gradient of an objective O with respect to parameters

$$\frac{dO}{dp} = \frac{\partial O}{\partial p} + {\sum }_{k} \frac{{dy}^{{( k )}^{T}}}{dp} \frac{\partial O}{\partial {y}^{k}} .$$

For systems with non-redundant constraints, assuming temporarily that

$$\frac{\partial {y}_{n}}{\partial {y}_{p}} = 0 ,$$

the dynamics optimization system 102 may derive from Equation 18 that the term k in the sum is

$$- \frac{\partial {F}^{T}}{\partial p} {( \frac{\partial F}{\partial {y}_{n}} )}^{- T} \frac{\partial O}{\partial {y}_{n}} .$$

Evaluating Equation 18 may require the solution of a linear system with as many right-hand sides as parameters p; the dynamics optimization system 102 may instead compute the adjoint vector

$${\overline{y}}_{n} := - {( \frac{\partial F}{\partial {y}_{n}} )}^{- T} \frac{\partial O}{\partial {y}_{n}} ,$$

solving the transposed system with a single right-hand side, and compute in a second step the product

$$\frac{\partial {F}^{T}}{\partial p} {\overline{y}}_{n} .$$

Taking into account dependencies across consecutive steps, the adjoint method for non-over-constrained systems may be represented by Algorithm 1 for systems with non-redundant constraints. Algorithm 1 may be implemented by the dynamics optimization system 102 and uses the adjoint method to update gradients of the objective with respect to states and parameters, from the end of the sequence to the beginning, assuming a fixed initial state y⁽⁰⁾, which may optionally depend on p. Algorithm 1 may be written for a BDF1 discretization (i.e. yₚ=y^{(k-1)} if yₙ=y^{(k)}); for higher-order discretizations, the update of line 4 in Algorithm 1 must be distributed accordingly to

$${g}_{y}^{( k - 1 )} , {g}_{y}^{( k - 2 )} , … ,$$

with the same weights as for computing the aggregate previous state yₚ.

Algorithm 1
$1. Initialize {g}_{p} := \frac{\partial O}{\partial p} and {g}_{y}^{( k )} := \frac{\partial O}{\partial {y}^{( k )}} for k = 0 , … n .$
2. For k = n to [symbol] , do:
$3. Compute the adjoint {\overline{y}}^{( k )} := - \frac{\partial {F}^{{( k )}^{- T}}}{\partial {y}_{n}} {g}_{k}$
$4. Update {g}_{y}^{( k - 1 )} += \frac{\partial {F}^{{( k )}^{T}}}{\partial {y}_{p}} {\overline{y}}^{( k )}$
$5. Update {g}_{p} += \frac{\partial {F}^{{( k )}^{T}}}{\partial p} {\overline{y}}^{( k )}$
$6. Update {g}_{p} += \frac{\partial {y}^{{( 0 )}^{T}}}{\partial p} {g}_{y}^{( 0 )}$
$7. Output {g}_{p} ( = \frac{dO}{dp} )$ [symbol]
indicates data missing or illegible when filed

Algorithm 2 may represent the over-constrained case for the same assumptions (fixed initial state, BDF1 discretization). While the standard adjoint method cannot be applied to the weighted least-norm multipliers, the dynamics optimization system 102 may ensure that only linear systems with a single righthand side are solved in Equation 20, as sensitivities to the multipliers are multiplied with a column vector in the updates of lines 3-5 and 9 in Algorithm 2. The adjoint vector computation on line 6 of Algorithm 2 may be done in the context of the reduced system without redundant constraints or multipliers.

Algorithm 2
$1. Initialize {g}_{p} := \frac{\partial O}{\partial p} and \{ \begin{matrix}\text{?} := \frac{\partial O}{\text{?}} \\ \text{?} := \frac{\partial O}{\text{?}} \\ {g}_{λ}^{( k )} := \frac{\partial O}{\partial {λ}^{( k )}}\end{matrix} for k = 0 , … , n \text{?}$
2. For k = n to [symbol] , do:
$3. Update \text{?} += \frac{\partial {λ}^{{( k )}^{T}}}{\text{?}} {g}_{λ}^{( k )}$
$4. Update \text{?} += \frac{\partial \text{?}}{\partial \text{?}} {g}_{λ}^{( k )}$
$5. Update \text{?} += \frac{\partial \text{?}}{\partial \text{?}} {g}_{λ}^{( k )}$
$6. Compute the adjoint \text{?} := - \frac{\partial {F}^{{( k )}^{- T}}}{\partial \text{?}} [ \begin{matrix}\text{?} \\ \text{?} \\ 0\end{matrix} ]$
$7. Update \text{?} += \frac{\partial {F}^{{( k )}^{T}}}{\partial \text{?}} \text{?}$
$8. Update \text{?} += \frac{\partial \text{?}}{\partial \text{?}} \text{?}$
$9. Update {g}_{p} += \frac{\partial {F}^{{( k )}^{T}}}{\partial p} \text{?} + \frac{\partial {λ}^{{( k )}^{T}}}{\partial p} {g}_{λ}^{( k )}$
$10. Update {g}_{p} += \frac{\partial {y}^{{( 0 )}^{T}}}{\partial p} {g}_{y}^{( 0 )}$
$11. Output {g}_{p} ( = \frac{dO}{dp} )$ [symbol]
indicates data missing or illegible when filed

In some embodiments, the dynamics optimization system 102 may utilize a semi-implicit Euler method. The semi-implicit method solves for velocities first and uses the updated velocities to integrate positions. The method uses a state consisting of the body pose, s=[c^{T} q^{T}]^{T}, and a twist u=[v^{T} ω^{T}]^{T}.

The equilibrium equation written in terms of twist is

$$M \dot{u} + h = {C}_{δ s}^{T} λ = 0$$

where M=

$$[ \begin{matrix}M \cdot I & 0 \\ 0 & J ( q )\end{matrix} ] , h = [ \begin{matrix}- f \\ ω \times ( J ( q ) ω ) - τ\end{matrix} ] ,$$

with the inertia expressed in global coordinates, J(q)=R(q)J_{rb}R(q)^{T}.

The constraint derivative, C_{δs}=[C_{c}, C_{ϕ}], is the derivative of the constraints with respect to the center of mass position and the incremental body orientation parameterized by a rotation vector, ϕ. The orientation derivative is therefore related to the derivative with respect to the quaternion via

$${C}_{ϕ} = {C}_{q} \frac{\partial ϕ}{\partial q} = \frac{1}{2} {C}_{q} {G}^{T} ( q ) ,$$

analogous to the relationship between the angular velocity and the time derivative of the quaternion (property 10 in Table 1). The time derivative of the constraints may be described as Ċ=C_{δs}u+C_{θ}θ, which is linear in the body twist. The second term accounts for changes in the control parameters.

Since enforcing constraint velocities to be zero may lead to numerical drift, the velocity constraint is stabilized through Baumgart stabilization described as

$$\dot{C} + \frac{α}{Δ t} C = 0 ,$$

with coefficient α ∈ [0, 1].

Simultaneously enforcing the equilibrium equations and constraint velocities may result in the continuous time system,

$$[ \begin{matrix}M & {C}_{δ s}^{T} \\ {C}_{δ s} & 0\end{matrix} ] [ \begin{matrix}\dot{u} \\ - λ\end{matrix} ] = [ \begin{matrix}- h \\ - {C}_{θ} \dot{θ} - \frac{α}{Δ t} C\end{matrix} ] .$$

By substituting time derivatives with finite differences and multiplying the equilibrium equations by Δt, the dynamics optimization system 102 may obtain the linear system

$$[ \begin{matrix}M & {C}_{δ s}^{T} \\ {C}_{δ s} & 0\end{matrix} ] [ \begin{matrix}{u}^{( k )} \\ - Δ t {λ}^{( k )}\end{matrix} ] = [ \begin{matrix}{Mu}^{( k - 1 )} - Δ th \\ - {C}_{θ} \frac{( {θ}^{( k )} - {θ}^{( k - 1 )} )}{Δ t} - \frac{α}{Δ t} C\end{matrix} ] .$$

Dynamics and constraint terms in these equations are evaluated at time k−1. The dynamics optimization system may solve this linear system to yield the updated twist and constraint forces. Afterward, the body pose may be integrated according to

c^{(k)}=c^{(k-1)}+Δtv^{(k)},q^{(k)}=exp(Δtω^{(k)}q^{(k-1)},

where the exponential map is used to convert the rotation vector Δtω to the corresponding quaternion.

In operation 212, the dynamics optimization system 102 deploys a dynamics model 128 (e.g., the dynamics model 128 generated at operation 210) to the physical robotic device 112. For example, the dynamics optimization system 102 may transmit the dynamics model 128, including the configurations of the robotic components of the robotic device 112 and the retargeted motion to the robotic device 112. In some embodiments, it is desired to optimize the dynamics model 128 of the robotic device 112 to achieve the target animation as closely as possible while constrained by kinematic constraints based on a dynamic characteristic of the robotic device 112.

In some examples, deploying the dynamics model 128 to the robotic device 112 may include modifying the configuration of a robotic component, adding a robotic component, and/or removing a robotic component. For example, where an active rotational constraint of the dynamics model 128 indicates that an arm of a robotic character must be below a certain length to remain within the torque thresholds of an actuator controlling the arm, deploying the dynamics model 128 to the robotic character may include modifying the arm to be below the specified length. In another example, where the dynamics model 128 includes a motion sequence of the arm of the robotic character configured to retarget the target animation as closely as possible while remaining within force thresholds of the arm, deploying the dynamics model 128 to the robotic character may include configuring the robotic character to move as specified by the motion sequence of the dynamics model 128.

In some examples, deploying the dynamics model 128 to the robotic device 112 may include executing the motion sequence of the dynamics model 128 to cause the robotic character to perform the motion sequence (e.g., a motion sequence representing target animation data 120).

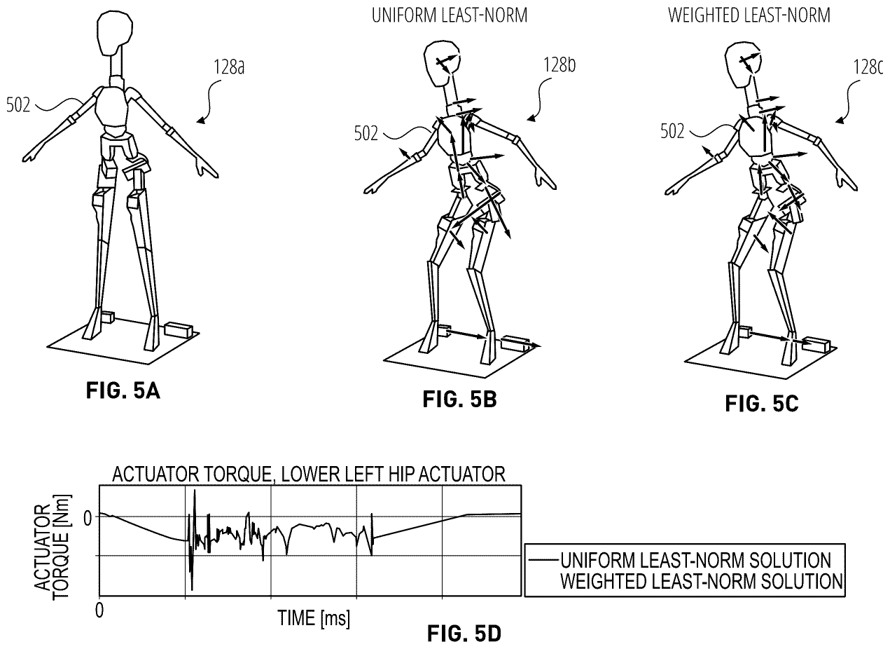

FIG. 5A, FIG. 5B, and FIG. 5C illustrate example dynamics model 128a, dynamics model 128b, and dynamics model 128b of a robotic device 112. As portrayed in FIG. 5A, an example robotic device (i.e., an animatronic character 502) may include a fixed base, with legs that form a kinematic loop with the ground. Several linkages of the animatronic character 502 may form smaller loops within this large loop, resulting in a complex kinematic structure (e.g., seven loops in total). Furthermore, the lower body may be over-actuated, e.g., with eight actuators in total to control six degrees of freedom of the pelvis. This may provide benefits with respect to the distribution of efforts and the regularization of otherwise singular configurations. However, the over-actuation may increase the complexity of the simulation of the dynamics model 128a, as actuators cannot be considered in isolation, since arbitrary motion inputs are now generally infeasible, and some kinematic constraints become redundant.

As discussed with respect to method 200, the dynamics optimization system 102 may be configured to generate a dynamics model 128 of the animatronic character 502 even with the over-actuated legs. The dynamics optimization system 102 may simulate a dancing animation on the animatronic character 502 with position-controlled actuators, using an inverse kinematics tool for motion retargeting to ensure that the set of actuator positions are always feasible.

The dynamics optimization system 102 may optimize the dynamics model 128a of the animatronic character 502. For example, due to the redundancy in the constraints, even though there is a single valid kinematic trajectory, there are several solutions to the dynamics problem in terms of forces and torques at the joints. To optimize the dynamics model 128a, as described with respect to method 200, the dynamics optimization system 102 may utilize a solution prioritizing actuator torque reduction.

For example, FIG. 5B portrays a dynamics model 128b of the animatronic character 502 generated using a naive uniform least-norm solution. In contrast, FIG. 5C portrays a dynamics model 128c of the animatronic character 502 generated by the dynamics optimization system 102 using a weighted least-norm solution described with respect to method 200.

FIG. 5D portrays a graph comparing the actuator torque (Nm) of a hip actuator of the animatronic character 502 between the dynamics model 128b of FIG. 5B and the dynamics model 128c of FIG. 5C. The dynamics model 128b of FIG. 5B generated using a naive uniform least-norm solution results in 63% higher root-mean-square torques, averaged over the 8 actuators in the legs compared to the dynamics model 128c of FIG. 5C generated by the dynamics optimization system 102 using a weighted least-norm solution.

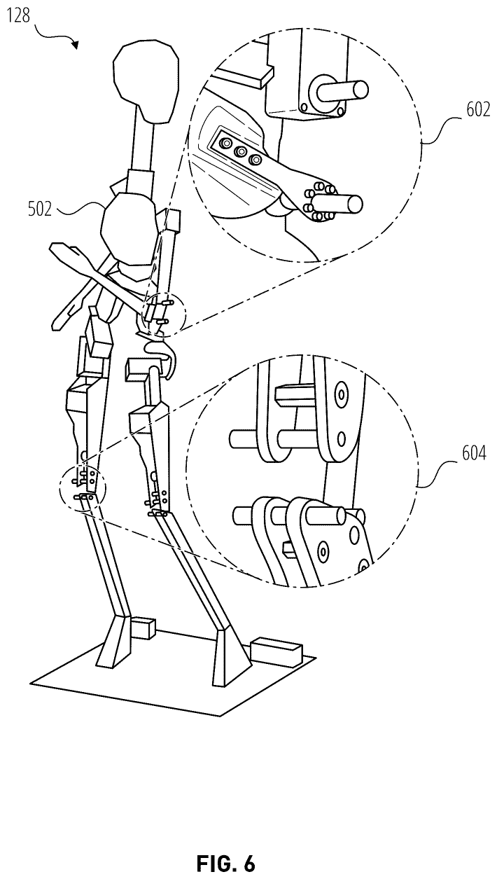

FIG. 6 illustrates an example dynamics model 128 of the animatronic character 502 indicating constraint violations. The dynamics optimization system 102 may simulate a motion of the animatronic character 502 with varied parameters, including parameters input by a user 126. Where the simulation indicates a constraint violation in a robotic component of the animatronic character 502 greater than a tolerance value, the dynamics model 128 generated by the dynamics optimization system 102 may provide feedback indicating the constraint violation. For example, elbow joint 602 and knee joint 604 of the animatronic character 502 display constraint violations for the position-based actuator at the elbow joint 602 and the passive degree of freedom in the knee joint 604. In this manner, a user 126 can iterate parameters of the dynamics model 128 and receive simulation feedback regarding constraint violations of the dynamics model 128.

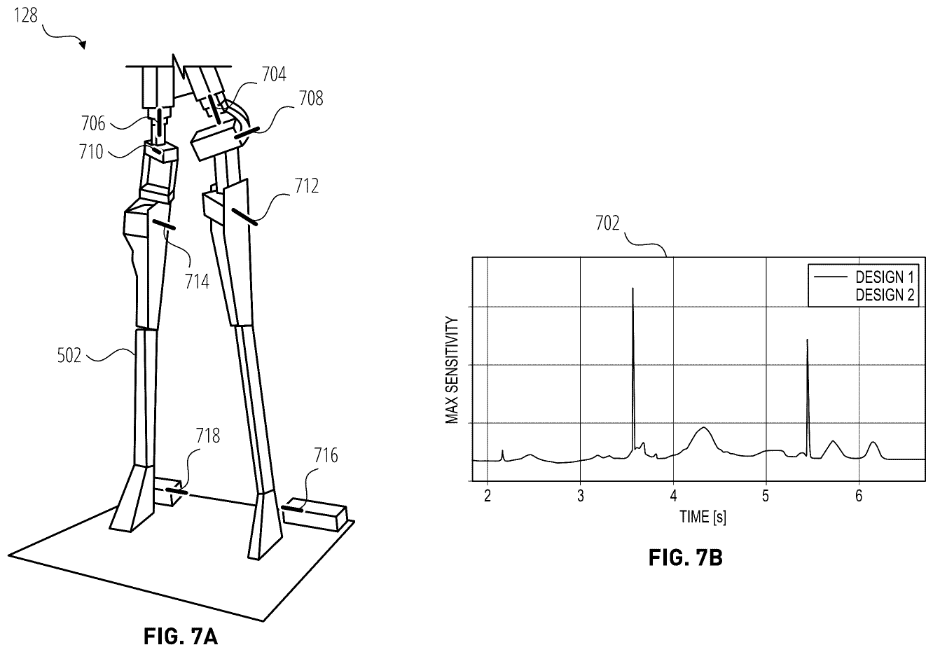

FIG. 7A and FIG. 7B illustrate an example dynamics model 128 of the animatronic character 502 indicating a sensitivity analysis based on varied designs. A user 126 and/or the dynamics optimization system 102 may vary the design of the animatronic character 502, and in response, the dynamics optimization system 102 may generate dynamics models 128 for the alternative designs indicating a sensitivity and/or instability analysis of the alternative designs.

For example, FIG. 7A portrays the over-actuated lower body of the animatronic character 502, with eight actuators in total (i.e., actuator 704, actuator 706, actuator 708, actuator 710, actuator 712, actuator 714, actuator 716, and actuator 718) to control the six degrees of freedom of the pelvis. The user 126 and/or the dynamics optimization system 102 may generate two alternative non-over-actuated designs for the animatronic character 502, in which two out of the eight actuators in the lower body are replaced with passive joints for cost and weight savings. For example, in alternative Design 1, actuator 704 and actuator 718 are replaced with passive joints, and in alternative Design 2, actuator 712 and actuator 714 are replaced with passive joints. While the kinematic sequences are identical, the choice of which actuators to remove affects the closeness to kinematic singularities and thus the motion stability on the physical system. Leveraging the differentiability of the dynamics model 128 generated by the dynamics optimization system 102, the dynamics optimization system 102 may guide design choices by computing, for the motion sequence, the sensitivity over time of rigid body poses to force-control inputs.

The worst-case sensitivity graph 702 portrayed in FIG. 7B, displays a comparison of Design 1 and Design 2 of the worst-case sensitivity of rigid body poses to lower-body actuator torque inputs (i.e. maximal absolute coefficient of the sensitivity matrix). As portrayed in the worst-case sensitivity graph 702, Design 2 features large sensitivity peaks at several points in the animation, indicating likely instabilities on the physical design.

FIG. 8 illustrates a block diagram of an example computer system suitable for use in embodiments disclosed herein in accordance with an embodiment of the disclosure. For example, the dynamics optimization system 102 may include or utilize one or several computing systems 800, and the processor 114 and memory 116 may be located at one or several computing systems 800. In various embodiments, the robotic device 112 is implemented by a computing system 800. In various implementations, the user device 106 and/or additional user devices may be implemented using any number of computing devices including, but not limited to a computer, laptop, tablet, mobile phone, smart phone, wearable device (e.g., AR/VR headset, smartwatch, smart glasses, or the like), smart speaker, vehicle (e.g., automobile), or appliance.

This disclosure contemplates any suitable number of computing systems 800. For example, the computing system 800 may be a server, a desktop computing system, a mainframe, a mesh of computing systems, a laptop or notebook computing system, a tablet computing system, an embedded computer system, a system-on-chip, a single-board computing system, or a combination of two or more of these. Where appropriate, the computing system 800 may include one or more computing systems; be unitary or distributed; span multiple locations; span multiple machines; span multiple data centers; or reside in a cloud, which may include one or more cloud components in one or more networks. The computing system 800 may include one or more processors 802, an input/output (I/O) interface 806, one or more external devices 808, one or more memory components 810, and a network interface 812. Each of the various components may be in communication with one another through one or more buses or communication networks, such as wired or wireless networks.

In some embodiments, various components of the computing system 800 may communicate with one another through the network 104. For example, in some embodiments, the computing system 800 may be implemented as a serverless service, where computing resources for various components of the computing system 800 may be located across various computing environments (e.g., cloud platforms) and may be reallocated dynamically and/or automatically according to, for example resource usage of the computing system 800. In various implementations, the computing system 800 may be implemented using organizational processing constructs such as functions implemented by worker elements allocated with compute resources, containers, virtual machines, and the like.

The processor 802 may be any type of electronic device capable of processing, receiving, and/or transmitting instructions. For example, the processor 802 may be a central processing unit, graphics processing unit, microprocessor, processor, or microcontroller. Additionally, it should be noted that some components of the computing system 800 may be controlled by a first processor and other components may be controlled by a second processor, where the first and second processors may or may not be in communication with each other. The dynamics optimization system 102, robotic device 112, and user device 106 may perform operations by executing executable instructions (e.g., software) using the processor 802. The processor 802 may be used to implement processor 114 shown in FIG. 1.

The I/O interface 806 allows a user to enter data in to computing system 800, as well as provides an input/output for the computing system 800 to communicate with other devices or services. The I/O interface 806 can include one or more input buttons, touch pads, and so on.

The external devices 808 are one or more devices that can be used to provide various inputs to the computing system 800, e.g., mouse, microphone, keyboard, trackpad, or the like. The external devices 808 may be local or remote and may vary as desired. In some examples, the external devices 808 may also include one or more additional sensors.

The memory components 810 are used by the computing system 800 to store instructions for the processor 114 and may be implemented as a data store and the like. The memory components 810 may be, for example, magneto-optical storage, read-only memory, random access memory, erasable programmable memory, flash memory, or a combination of one or more types of memory components. The memory components 810 may be used to implement the memory 116 shown in FIG. 1. The memory 116 may include various instructions for various functions of the dynamics optimization system 102 which, when executed by the processor 114, perform various functions of the dynamics optimization system 102. The memory 116 may further store data and/or instructions for retrieving data used by the dynamics optimization system 102. Similar to the processor 114, the memory 116 utilized by the dynamics optimization system 102 may be distributed across various physical computing devices. In some examples, the memory 116 may access instructions and/or data from other devices or locations, and such instructions and/or data may be read into memory 116 to implement the dynamics optimization system 102.

The network interface 812 provides communication to and from the computing system 800 to other devices. The network interface 812 includes one or more communication protocols, such as, but not limited to Wi-Fi, Ethernet, Bluetooth®, and so on. The network interface 812 may also include one or more hardwired components, such as a Universal Serial Bus (USB) cable, or the like. The configuration of the network interface 812 depends on the types of communication desired and may be modified to communicate via Wi-Fi, Bluetooth, and so on.

The network interface 812 may interface with the network 104. The network 104 may be implemented using one or more wired and/or wireless systems and protocols for communications between computing devices. In various embodiments, the network 104 or various portions of the network 104 may be implemented using the internet, a local area network, a wide area network, and/or other networks. In addition to traditional data networking protocols, in some embodiments, data may be communicated according to protocols and/or standards including near field communication, Bluetooth®, Wi-Fi, cellular connections, or the like.

The display 804 provides a visual output for the computing devices and may be varied as needed based on the device. The display 804 may be configured to provide visual feedback to the user and may include a liquid crystal display screen, light emitting diode screen, plasma screen, or the like. In some examples, the display 804 may be configured to act as an input element for the user through touch feedback or the like.

The components in FIG. 8 are exemplary only. In various examples, the computing system 800 may include additional components and/or functionality not shown in FIG. 8.

Accordingly, the dynamics optimization system 102 described herein addresses particular challenges and needs presented by systems for generating a dynamics model 128 of a robotic device 112. For example, the dynamics model 128 generated by the dynamics optimization system 102 is an implicitly-integrated constrained rigid body dynamics that is quaternion-based, together with a modular set of constraints that facilitates the implementation of common joints and actuators. The implicit integration satisfies constraints to numerical tolerances, and the solver strategy employed by the dynamics optimization system 102 simulates systems with either less or more constraints than unknown states or over-actuation. In comparison to traditional simulators that keep quaternions at unit length with specialized non-additive gradient updates, system of discretized equations of the dynamics optimization system 102 is well-suited for symbolic differentiation and numerical optimization with standard additive updates. Moreover, the dynamics optimization system 102 simulator remains fully differentiable, even if subspaces are present in constraint forces or torques, or corresponding Lagrange multipliers.

The technology described herein may be implemented as logical operations and/or modules in one or more systems. The logical operations may be implemented as a sequence of processor-implemented steps directed by software programs executing in one or more computer systems and as interconnected machine or circuit modules within one or more computer systems, or as a combination of both. Likewise, the descriptions of various component modules may be provided in terms of operations executed or effected by the modules. The resulting implementation is a matter of choice, dependent on the performance requirements of the underlying system implementing the described technology. Accordingly, the logical operations making up the embodiments of the technology described herein are referred to variously as operations, steps, objects, or modules. Furthermore, it should be understood that logical operations may be performed in any order, unless explicitly claimed otherwise or a specific order is inherently necessitated by the claim language.

In some implementations, articles of manufacture are provided as computer program products that cause the instantiation of operations on a computer system to implement the procedural operations. One implementation of a computer program product provides a nontransitory computer program storage medium readable by a computer system and encoding a computer program. It should further be understood that the described technology may be employed in special purpose devices independent of a personal computer.

The description of certain embodiments included herein is merely exemplary in nature and is in no way intended to limit the scope of the disclosure or its applications or uses. In the included detailed description of embodiments of the present systems and methods, reference is made to the accompanying figures which form a part hereof, and which are shown by way of illustration specific to embodiments in which the described systems and methods may be practiced. These embodiments are described in sufficient detail to enable those skilled in the art to practice presently disclosed systems and methods, and it is to be understood that other embodiments may be utilized, and that structural and logical changes may be made without departing from the spirit and scope of the disclosure. Moreover, for the purpose of clarity, detailed descriptions of certain features will not be discussed when they would be apparent to those with skill in the art so as not to obscure the description of embodiments of the disclosure. The included detailed description therefore is not to be taken in a limiting sense, and the scope of the disclosure is defined only by the appended claims.

From the foregoing it will be appreciated that, although specific embodiments of the invention have been described herein for purposes of illustration, various modifications may be made without deviating from the spirit and scope of the invention.

Although the methods described herein (e.g., method 200) depict a particular sequence of operations, the sequence may be altered without departing from the scope of the present disclosure. For example, some of the operations depicted may be performed in parallel or in a different sequence that does not materially affect the function of the routine. In other examples, different components of an example device or system that implements the routine may perform functions at substantially the same time or in a specific sequence.

The particulars shown herein are by way of example and for purposes of illustrative discussion of the preferred embodiments of the present disclosure and are presented in the cause of providing what is believed to be the most useful and readily understood description of the principles and conceptual aspects of various embodiments of the invention. In this regard, no attempt is made to show structural details of the invention in more detail than is necessary for the fundamental understanding of the invention, the description taken with the figures and/or examples making apparent to those skilled in the art how the several forms of the invention may be embodied in practice.

As used herein and unless otherwise indicated, the terms “a” and “an” are taken to mean “one”, “at least one” or “one or more”. Unless otherwise required by context, singular terms used herein shall include pluralities and plural terms shall include the singular.

Unless the context clearly requires otherwise, throughout the description and the claims, the words ‘comprise’, ‘comprising’, and the like are to be construed in an inclusive sense as opposed to an exclusive or exhaustive sense; that is to say, in the sense of “including, but not limited to”. Words using the singular or plural number also include the plural and singular number, respectively. Additionally, the words “herein,” “above,” and “below” and words of similar import, when used in this application, shall refer to this application as a whole and not to any particular portions of the application.

All relative, directional, and ordinal references (including top, bottom, side, front, rear, first, second, third, and so forth) are given by way of example to aid the reader's understanding of the examples described herein. They should not be read to be requirements or limitations, particularly as to the position, orientation, or use unless specifically set forth in the claims. Connection references (e.g., attached, coupled, connected, joined, and the like) are to be construed broadly and may include intermediate members between a connection of elements and relative movement between elements. As such, connection references do not necessarily infer that two elements are directly connected and in fixed relation to each other, unless specifically set forth in the claims.

Of course, it is to be appreciated that any one of the examples, embodiments or processes described herein may be combined with one or more other examples, embodiments and/or processes or be separated and/or performed amongst separate devices or device portions in accordance with the present systems, devices and methods.

Finally, the above discussion is intended to be merely illustrative of the present system and should not be construed as limiting the appended claims to any particular embodiment or group of embodiments. Thus, while the present system has been described in particular detail with reference to exemplary embodiments, it should also be appreciated that numerous modifications and alternative embodiments may be devised by those having ordinary skill in the art without departing from the broader and Intended spirit and scope of the present system as set forth in the claims that follow. Accordingly, the specification and figures are to be regarded in an illustrative manner and are not intended to limit the scope of the appended claims.

What is claimed is:

1. A computer-implemented method for generating a dynamics model of a robotic device, comprising:
receiving, via a processor, a target animation for the robotic device;
receiving, via the processor, a kinematic model of the robotic device, the kinematic model comprising a movement characteristic of a first robotic component of the robotic device;
generating, via the processor, a motion representation for the first robotic component based on the target animation and the kinematic model;
generating, via the processor, a kinematic constraint of the first robotic component based on a dynamic characteristic of the first robotic component;
generating, via the processor, a dynamics model of the first robotic component based on the motion representation and the kinematic constraint; and
deploying, via the processor, the dynamics model to the robotic device.

2. The computer-implemented method of claim 1, wherein the kinematic model comprises at least one of an over-constrained, over-actuated, under-constrained, or under-actuated model of the robotic device.

3. The computer-implemented method of claim 1, wherein the movement characteristic of the first robotic component comprises a parameter defining a relative motion between the first robotic component and a second robotic component.

4. The computer-implemented method of claim 1, wherein the motion representation for the first robotic component maintains dynamic equilibrium in the first robotic component during a motion of the first robotic component.

5. The computer-implemented method of claim 4, wherein the motion representation for the first robotic component is based on a Euler-Lagrange relationship.

6. The computer-implemented method of claim 1, wherein the kinematic constraint comprises a translational constraint restricting a translational motion between the first robotic component and a second robotic component of the robotic device.

7. The computer-implemented method of claim 1, wherein the kinematic constraint comprises a rotational constraint restricting an angular motion between the first robotic component and a second robotic component of the robotic device.

8. The computer-implemented method of claim 1, wherein the dynamic characteristic of the first robotic component comprises at least one of a mass of the first robotic component, a torque applied to the first robotic component, or a force applied to the first robotic component.

9. The computer-implemented method of claim 1, wherein generating the kinematic constraint of the first robotic component based on the dynamic characteristic of the first robotic component comprises:
determining a dynamic tolerance of the first robotic component based on the dynamic characteristic; and
generating the kinematic constraint to restrict a dynamic motion of the first robotic component within the dynamic tolerance.

10. The computer-implemented method of claim 1, wherein generating the dynamics model of the first robotic component based on the motion representation and the kinematic constraint comprises solving the motion representation to satisfy the kinematic constraint.

11. A system for generating a dynamics model of a robotic device, comprising:
the robotic device;
a datastore; and
a processor configured by instructions to perform operations comprising:
receiving a target animation for the robotic device;
receiving a kinematic model of the robotic device, the kinematic model comprising a movement characteristic of a first robotic component of the robotic device;
generating a motion representation for the first robotic component based on the target animation and the kinematic model;
generating a kinematic constraint of the first robotic component based on a dynamic characteristic of the first robotic component;
generating a dynamics model of the first robotic component based on the motion representation and the kinematic constraint; and
deploying the dynamics model to the robotic device.

12. The system of claim 11, wherein the kinematic model comprises at least one of an over-constrained, over-actuated, under-constrained, or under-actuated model of the robotic device.

13. The system of claim 11, wherein the movement characteristic of the first robotic component comprises a parameter defining a relative motion between the first robotic component and a second robotic component.

14. The system of claim 11, wherein the motion representation for the first robotic component maintains dynamic equilibrium in the first robotic component during a motion of the first robotic component.

15. The system of claim 14, wherein the motion representation for the first robotic component is based on a Euler-Lagrange relationship.

16. The system of claim 11, wherein the kinematic constraint comprises a translational constraint restricting a translational motion between the first robotic component and a second robotic component of the robotic device.

17. The system of claim 11, wherein the kinematic constraint comprises a rotational constraint restricting an angular motion between the first robotic component and a second robotic component of the robotic device.

18. The system of claim 11, wherein the dynamic characteristic of the first robotic component comprises at least one of a mass of the first robotic component, a torque applied to the first robotic component, or a force applied to the first robotic component.

19. The system of claim 11, wherein generating the kinematic constraint of the first robotic component based on the dynamic characteristic of the first robotic component comprises:
determining a dynamic tolerance of the first robotic component based on the dynamic characteristic; and
generating the kinematic constraint to restrict a dynamic motion of the first robotic component within the dynamic tolerance.

20. The system of claim 11, wherein generating the dynamics model of the first robotic component based on the motion representation and the kinematic constraint comprises solving the motion representation to satisfy the kinematic constraint.
